(19) United States
(12) Patent Application Publication
(10) Pub. No.: US 2010/0251255 A1
(43) Pub. Date: Sep. 30, 2010

(54) SERVER DEVICE, COMPUTER SYSTEM, RECORDING MEDIUM AND VIRTUAL COMPUTER MOVING METHOD

(75) Inventors: Ryo MIYAMOTO, Kawasaki (JP); Ryuichi Matsukura, Kawasaki (JP); Takashi Ohno, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/732,564

(22) Filed: Mar. 26, 2010

(30) Foreign Application Priority Data
Mar. 30, 2009 (JP) 2009-082525

(51) Int. Cl. G06F 9/46; G06F 3/00; G06F 3/048; G06F 21/04

(52) U.S. Cl. 718/104; 710/16; 715/810; 726/17

(57) ABSTRACT

A server device which operates a plurality of virtual computers so as to respectively correspond to a plurality of terminal devices to which physical devices are connected, the server device includes a judging unit that judges whether move of each of the plurality of virtual computers to each of the plurality of terminal devices is possible; a moving unit that moves one corresponding virtual computer to one terminal device move of the corresponding virtual computer to which has been judged to be possible using the judging unit; and an allocating unit that allocates one physical device connected to the terminal device concerned to the virtual computer which has been moved to the terminal device using the moving unit.

### CROSS-REFERENCE TO RELATED APPLICATIONS

This application is based upon and claims the benefit of priority of the prior Japanese Patent Application No. 2009-082525, filed on Mar. 30, 2009, the entire contents of which are incorporated herein by reference.

### FIELD

The embodiments relate to a server device, a computer system, a recording medium and a virtual computer moving method used to gain access from a virtual machine which is operated in the server device to a physical device connected to a terminal device.

### BACKGROUND

Recently a virtualizing technique of simultaneously operating virtual machines as a plurality of virtual computers in one server has been widely used. A system of allocating a plurality of virtual machines which are operated in a host server respectively to a plurality of client terminals by applying this virtualizing technique to a client OS (Operating System) is proposed. It may become possible for a user who is operating each client terminal to utilize virtual machines operated in the host server via a network by using the above system. The number of host servers used is not limited to one and it is also practiced to operate a plurality of virtual machines in a plurality of host servers. In relation to the above, techniques of moving virtual machines from one host server to another host server so as to operate respective virtual machines under optimum resources environments in a plurality of host servers are known (see, for example, Japanese Laid-open Patent Publication Nos. 2006-244481, 10-283210 and 2008-217332).

Physical devices such as a Web camera, a DVD (Digital Versatile Device) drive and a USB (Universal Serial Bus) memory are connected to each client terminal. A virtual machine which is operated in a host server and which has been allocated to the client terminal concerned gains access to a physical device connected to the client terminal via a network, for example, using RDP (Remote Desktop Protocol). In the case that, for example, the Web camera is used as the physical device, the virtual machine gains accesses to the Web camera via the network to receive image data from the camera at all times. In the case that, for example, the DVD drive is used as the physical device, the virtual machine gains access to the DVD drive into which a recording medium is inserted via the network to receive data which is read out using the DVD drive.

### SUMMARY

According to an aspect of the invention, a server device which operates a plurality of virtual computers so as to respectively correspond to a plurality of terminal devices to which physical devices are connected, the server device includes a judging unit that judges whether move of each of the plurality of virtual computers to each of the plurality of terminal devices is possible; a moving unit that moves one corresponding virtual computer to one terminal device move of the corresponding virtual computer to which has been judged to be possible using the judging unit; and an allocating unit that allocates one physical device connected to the terminal device concerned to the virtual computer which has been moved to the terminal device using the moving unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a computer system;

FIG. 2A illustrates an example of a functional configuration of a host server;

FIG. 2B illustrates an example of a functional configuration of a client terminal;

FIG. 3 is a block diagram of hardware;

FIG. 4 is a block diagram of hardware;

FIG. 5 illustrates an example of a functional configuration of each device;

FIG. 6 illustrates an example of a record layout of a local resources information table;

FIG. 7 illustrates an example of a record layout of a resources information table;

FIG. 8 illustrates an example of a record layout of a connection table;

FIG. 9 illustrates an example of a functional configuration of each device;

FIG. 10 illustrates processing of a VM starting-up process;

FIG. 11 illustrates processing of a remote connecting process;

FIG. 12 illustrates processing of a connection table updating process;

FIG. 13 illustrates processing of a move requesting process;

FIG. 14 illustrates processing of a moving process;

FIG. 15 illustrates processing of a move judging process;

FIG. 16 illustrates processing of a returning process;

FIG. 17 illustrates an example of a functional configuration of each device;

FIG. 18A illustrates an example of a screen for selecting physical device;

FIG. 18B illustrates an example of the screen for selecting the physical device;

FIG. 19A illustrates an example of a screen for selecting a move destination terminal;

FIG. 19B illustrates an example of the screen for selecting the move destination terminal;

FIG. 20 illustrates an example of a screen for accepting a return instruction;

FIG. 21 illustrates processing of a move destination terminal selecting process;

FIG. 22 illustrates processing of the move destination terminal selecting process;

FIG. 23 illustrates processing of a list preparing process;

FIG. 24 illustrates processing of a returning process;

FIG. 25 illustrates processing of a returning process;

FIG. 26 illustrates an example of a functional configuration of each device;

FIG. 27 illustrates an example of a record layout of an access limitation table;

FIG. 28 illustrates processing of an access limiting process; and

FIG. 29 illustrates processing of an access limiting process.

### DESCRIPTION OF EMBODIMENTS

### Embodiment 1

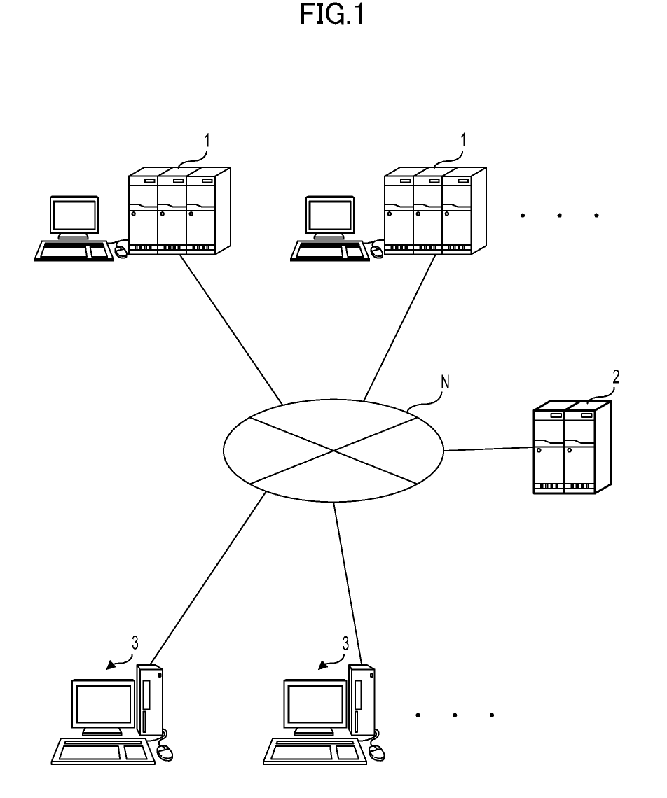

FIG. 1 illustrates an example of a computer system. The computer system includes a plurality of host servers (computers) 1 acting as server devices, a management server (computer) 2 acting as a management device and a plurality of client (computer) terminals 3 acting as terminal devices. The host servers 1, the management server 2 and the client terminals 3 are connected so as to communicate with one another via a network N. The host server 1 executes a VMM (Virtual Machine Monitor) as a virtualizing program.

The host server 1 makes a plurality of VMs (Virtual Machines) acting as a plurality of virtual computers (virtual machines) operate in accordance with the VMM. Hereinafter, the VMM that the host server 1 executes and the VM which is operated in accordance with the VMM will be respectively referred to as a host VMM and a host VM. As an example of the VMM, for example, Xen may be given. The client terminal 3 is, for example, a personal computer or an input/output device having a function of executing the VMM and an inputting/outputting function similarly to the host server 1. Each of the client terminals 3 is allocated to each of the host VMs which are operated in the host server 1 so as to be remotely operated from each client terminal 3. Owing to the above mentioned arrangement, the host server 1 and the client terminal 3 function as a host server and a thin client terminal of a thin client system. The number of the host servers 1 and the number of the client terminals need not necessarily be plural and may be singular.

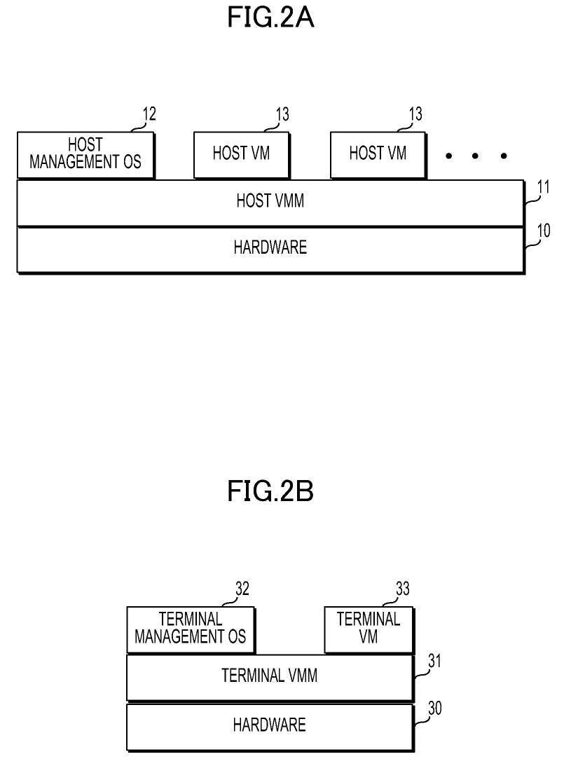

FIG. 2A and FIG. 2B illustrate examples of a functional configuration of each host server 1 and each client terminal 3. FIG. 2A illustrates the functional configuration of the host server 1. FIG. 2B illustrates the functional configuration of the client terminal 3. The host server 1 includes hardware 10, a host VMM 11, a host management OS 12 and a plurality of host VMs 13. The host management OS 12 is operated in accordance with the host VMM 11 similarly to the plurality of host VMs 13. The host VMM 11 is programmed to allocate physical devices included in the hardware 10 to the respective host VMs 13 so as to be accessible to each physical device from each host VM 13. The host management OS 12 is configured to manage resources information as computational resources that each host VM 13 uses and to transmit the resources information concerned to the management server 2 at all times.

The client terminal 3 executes a VMM similarly to the host server 1 and each VM is operated in accordance with the VMM concerned. Hereinafter, the VMM executed using the client terminal 3 and the VM operated in accordance with the VMM concerned will be referred to as a terminal VMM and a terminal VM. The client terminal 3 includes hardware 30, a terminal VMM 31, a terminal management OS 32 and one terminal VM 33. The terminal management OS 32 is operated in accordance with the terminal VMM 31 similarly to the terminal VM 33. The terminal VMM 31 is programmed to allocate a physical device included in the hardware 30 to the terminal VM 33 so as to be accessible to the physical device from the terminal VM 33.

The terminal management OS 32 is configured to manage resources information as computational resources that the terminal VM 33 uses and to transmit the resources information concerned to the management server 2 at all times. One of the plurality of host VMs 13 which are operated in the host server 1 is set so as to correspond to the terminal VM 33. Each terminal VM 33 is configured to be remotely connected to its corresponding host VM 13 so as to remotely operate each host VM 13 from each client terminal 3.

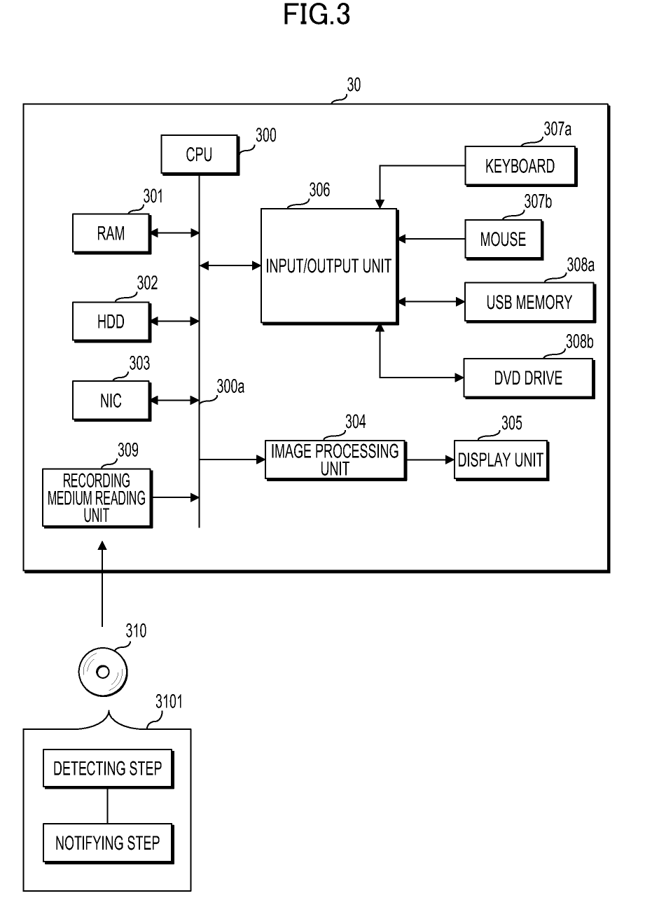

FIG. 3 is a block diagram of the hardware 30. The hardware 30 includes a CPU (Central Processing Unit) 300, a RAM (Random-Access Memory) 301 and an HDD (Hard Disk Drive) 302. The hardware 30 also includes an NIC (Network Interface Card) 303, an image processing unit 304, a display unit 305, an input/output unit 306 and a recording medium reading unit 309. The CPU 300 is configured to read a program 3101 out of a recording medium 310 inserted into the recording medium reading unit 309 and to store the read program in the HDD 302. A CD (Compact Disk) and a DVD may be given as examples of the recording medium 310. The CPU 300 reads the program 3101 stored in the HDD 302 into the RAM 301 and executes the program.

The image processing unit 304 is configured to generate an image signal on the basis of image information given from the CPU 300 and output the generated image signal to the display unit 305 to be displayed thereon. The display unit 305 is, for example, a liquid crystal display. As examples of the RAM 301, for example, an SRAM (Static RAM), a DRAM (Dynamic RAM) and a flash memory may be given. The RAM 301 temporarily stores various data generated when the CPU 300 executes each of various programs such as the terminal VMM 31. A keyboard 307a and a mouse 307b are connected to the input/output unit 306 as basic input devices that accept an operation from a user. The basic input device is not limited to the keyboard or the mouse and a touch panel may be also used as the basic input device.

A USB memory (slot) 308a and a DVD drive 308b are also connected to the input/output unit 306. Recording media such as a USB memory and a DVD are inserted into and detachably attached to the USB memory (slot) 308a and the DVD drive 308b. The input/output unit 306 is configured to send a notification that a physical device has been connected to the CPU 300 in the case that the recording medium has been inserted into or attached to the USB memory (slot) 308a or the DVD drive 308b. In the case that an external input/output apparatus such as a printer has been connected to the input/output unit 306, the input/output unit 306 may notify the CPU 300 of the input/output apparatus as a physical device which has been connected to the client terminal 3. The input/output apparatus also includes a scanner, a digital camera and a microphone. The CPU 300 is configured to detect the connected physical device (detecting step) and to notify the host management OS 12 of the connected physical device (notifying step) in accordance with instructions set in the program 3101.

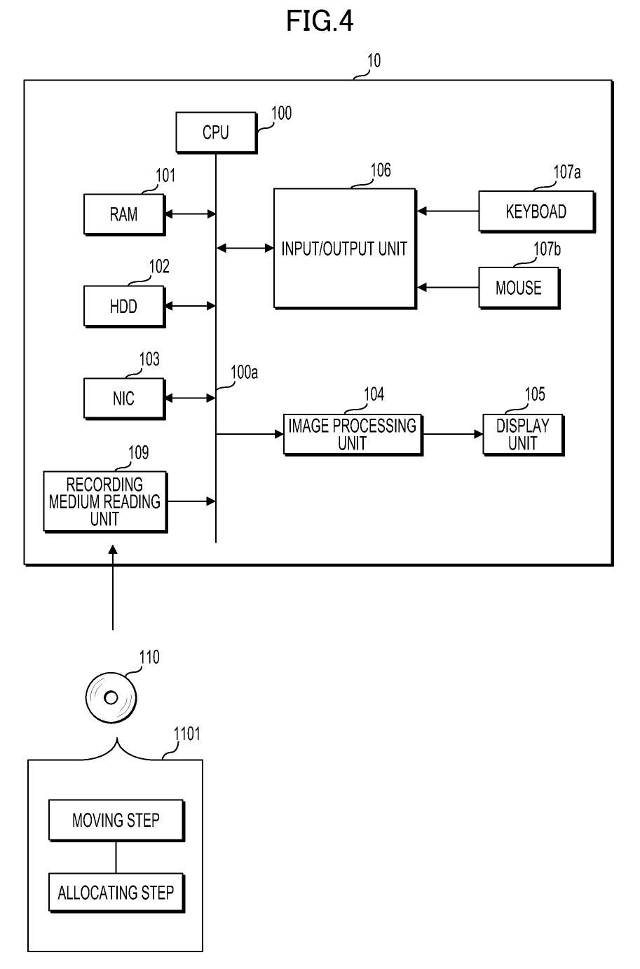

FIG. 4 is a block diagram of the hardware 10. The hardware 10 includes a CPU 100, a RAM 101 and an HDD 102. The hardware 10 also includes an NIC 103, an image processing unit 104, a display unit 105, an input/output unit 106 and a recording medium reading unit 109. The CPU 100 is configured to read a program 1101 out of a recording medium 110 inserted into the recording medium reading unit 109 and store the read program into the HDD 102. The CPU 100 reads the program 1101 stored in the HDD 102 into the RAM 101 and executes the program. The RAM 101 temporarily stores various data generated when the CPU 100 executes each of various programs such as the host VMM 11.

A keyboard 107a and a mouse 107b are connected to the input/output unit 106 as basic input/output devices. A USB memory, a DVD drive and an external input/output apparatus may be connected to the input/output unit 106 similarly to the input/output unit 306. The input/output unit 106 is configured to notify the CPU 100 of a physical device which has been connected to the host server similarly to the input/output unit 306. The CPU 100 is configured to move the host VM 13 (moving step) and allocate a physical device thereto (allocating step) in accordance with instructions set in the program 1101.

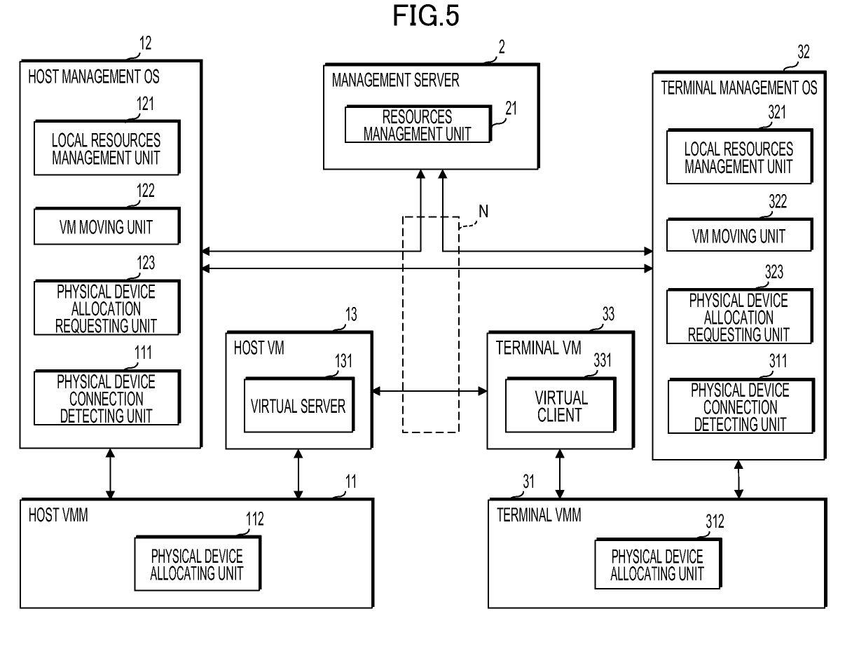

FIG. 5 illustrates a example of a functional configuration of each devices. The host VMM 11 includes a physical device allocating unit 112 serving as an allocating unit. The physical device allocating unit 112 is configured to allocate a physical device to the host VM 13 in accordance with an allocation request received from the host management OS 12. The host VM 13 to which the physical device has been allocated using the physical device allocating unit 112 turns accessible to the physical device concerned. The physical device allocating unit 112 also serves as a deallocating unit by deallocating the physical device from the host VM 13.

The host management OS 12 includes a physical device connection detecting unit 111 serving as detecting means, a local resources management unit 121, a VM moving unit 122 serving as a moving unit and a physical device allocation requesting unit 123. The physical device connection detecting unit 111 is configured to detect a physical device connected to or disconnected from the input/output unit 106. The local resources management unit 121 manages resources information as computational resources that the host management OS 12 and the host VM 13 use. The host management OS 12 is configured to transmit the resources information managed using the local resources management unit 121 to the management server 2. The VM moving unit 122 is configured to move the host VM 13 from the host server 1 to the client terminal 3. The physical device allocation requesting unit 123 is configured to transmit the allocation request or a deallocation request to the physical device allocating unit 112.

The allocation request and the deallocation request respectively indicate physical devices to be allocated and deallocated and the host VMs 13 of allocation and deallocation destinations. The host VM 13 includes a virtual server 131 used to establish remote connection with the terminal VM 33 via the network N. The virtual server 131 is provided by executing a server program for establishing remote desktop connection, for example, using the above mentioned RDP. The server program may be executed using an OS which is operated in the host VM 13.

The terminal VMM 31 includes a physical device allocating unit 312. The physical device allocating unit 312 is configured to allocate a physical device to the terminal VM 33 which is operated in accordance with the terminal VMM 31 in response to the allocation request received from the terminal management OS 32. The terminal VM 33 to which the physical device has been allocated using the physical device allocating unit 312 turns accessible to the physical device concerned.

The terminal management OS 32 includes a physical device connection detecting unit 311, a local resources management unit 321, a VM moving unit 322 serving as a moving unit and a physical device allocation requesting unit 323. The local resources management unit 321 manages resources information as computational resources that the terminal management OS 32 and the terminal VM 33 use. The terminal management OS 32 is configured to transmit the resources information that the local resource management unit 321 manages to the management server 2. The physical device connection detecting unit 311 is configured to detect a physical device which is connected to or disconnected from the input/output unit 306. The VM moving unit 322 is configured to move the host VM 13 which has been moved to the client terminal 3 back to the host server 1 as a source from which the host VM 13 has been moved (hereinafter, referred to as a move source). The physical device allocation requesting unit 323 is configured to transmit the allocation request and the deallocation request to the physical device allocating unit 312. The allocation request and the deallocation request respectively indicate physical devices to be allocated and deallocated and the terminal VMs 33 as the allocation destination and the deallocation destination.

The terminal VM 33 includes a virtual client 331 used to establish remote connection with the host VM 13 via the network N. The virtual client 331 is provided by executing a client program for establishing remote desktop connection using, for example, the above mentioned RDP. The client program may be executed in an OS which is operated in the terminal VM 33. Owing to remote connection between the virtual server 131 and the virtual client 331, the client terminal 3 is remote-connected to the host VM 13. The host management OS 12 or the terminal management OS 32 is configured to notify the management server 2 of connection information in the case that remote connection has been established between the host VM 13 and the terminal VM 33.

The management server 2 includes a resources management unit 21. The resources management unit 21 is configured to manage the resources information and the connection information transmitted from the host management OS 12 and the terminal management OS 32. The management server 2 is also configured to function as a judging unit that judges whether move of the host VM 13 from the host server 1 to the client terminal 3 is possible. The virtual client 331 is configured to transmit an operation which has been performed by a user accepted using the keyboard 307a or the mouse 307b of the client terminal 3 to the virtual server 131. The virtual server 131 is configured to execute a process according to the received operation and to transmit screen information according to a process execution result to the virtual client 331. The virtual client 331 is configured to display the transmitted screen information on the display unit 305 included in the client terminal 3.

The local resources management unit 121 is configured to store a local resources information table in the HDD 102 to manage the resources information on the basis of the stored local resources information table. The resource information includes the type name of a CPU used, the number of cores used, a free memory capacity, a used memory capacity and a connected physical device. The type name of a CPU used is the type name of the CPU 100 of the host server 1 in which the host management OS 12 and the host VM 13 are operated. The number of cores used is the number of processor cores that the host management OS 12 and the host VM 13 respectively use in one or a plurality of processor cores that the CPU 100 has. The host management OS 12 uses all the processor cores that the CPU 100 has and hence the number of cores used by the host management OS is the same as the number of cores that the CPU 100 has.

The used memory capacity indicates a memory capacity which is allocated to and used in the host management OS 12 or the host VM 13 in a memory capacity that the RAM 101 retains. The free memory capacity indicates a not used memory capacity in the memory capacity that the RAM 101 retains. The local resources information table includes the IP addresses allocated to the host management OS 12 and the host VM 13.

The local resources information table includes information used to designate the host server 1 in which the host management OS 12 and the host VM 13 are operated. The local resources management unit 321 is configured to store the local resources information table in the HDD 302 and to manage the resources information on the basis of the stored local resources information table similarly to the local resources management unit 121. The terminal management OS 32 uses all the processor cores that the CPU 300 has similarly to the host management OS 12 and the number of cores used is the same as the number of cores that the CPU 300 has.

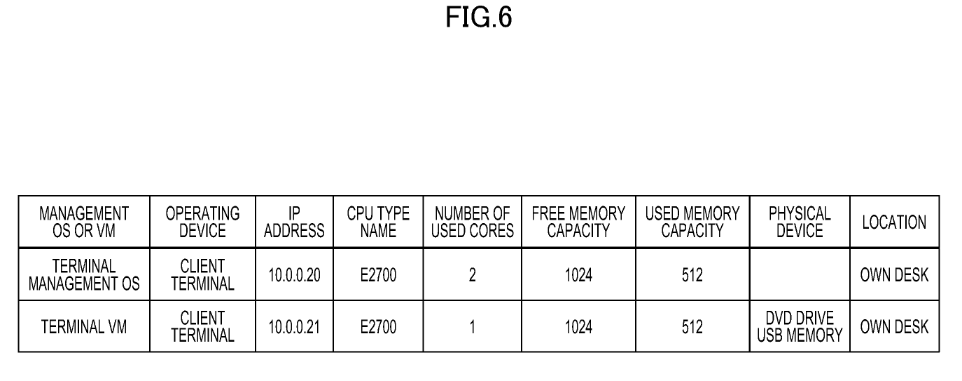

FIG. 6 illustrates an example of a record layout of the local resources information table. FIG. 6 illustrates an example of the local resources information table that the local resources management unit 321 included in the client terminal 3 stores in the HDD 302. In the example illustrated in FIG. 6, the table includes “E2700” indicative of the type name of the CPU in which the terminal VM 33 is operated and “1” indicative of the number of cores that the terminal VM 33 uses. The example of the resources information of the terminal VM 33 illustrated in FIG. 6 also includes “1024” indicative of the free memory capacity of the RAM 301 and “512” indicative of the memory capacity of the RAM 301 that the terminal VM 33 uses.

The example further includes “DVD Drive, USB Memory” indicative of physical devices which have been connected to the client terminal 3 and detected using the physical device connection detecting unit 311. In addition, in the example illustrated in FIG. 6, the free memory capacity and the used memory capacity are stored, for example, in units of MB (Mega Byte). “10.0.0.21” indicative of the IP address of the terminal VM 33 and “Own Desk” indicative of the installed location thereof are stored so as to correspond to the terminal VM 33. The location “Own Desk” indicates that the client terminal 3 in which the terminal VM 33 is operated is installed in a place where the user is present.

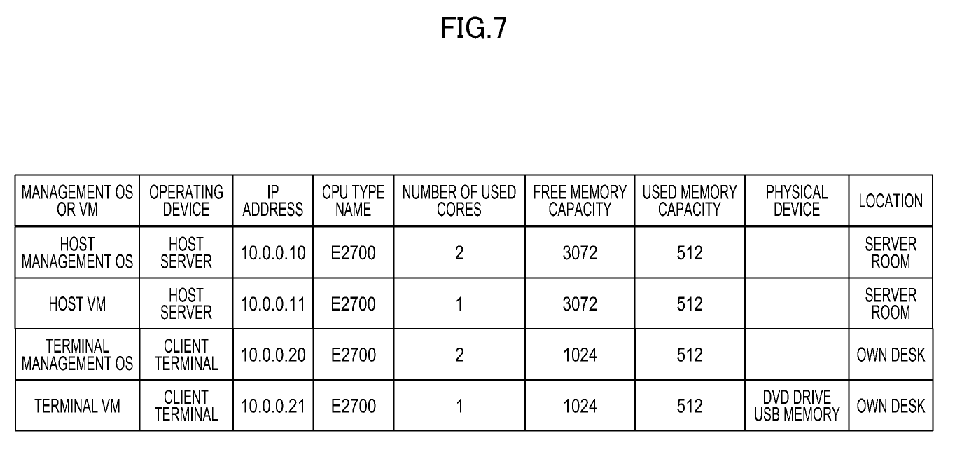

FIG. 7 illustrates an example of a record layout of a resources information table. The resources management unit 21 of the management server 2 is configured to store the resources information table in an HDD not illustrated in the drawing and manage the resources information sent from the host management OS 12 and the terminal management OS 32 on the basis of the stored resources information table. The resources management unit 21 manages the resource information of all the management OSs and VMs which are operated in the host servers 1 and the client terminals 3 in accordance with the data in the resources information table. In the example illustrated in FIG. 7, the local resources information stored in the HDD 302 as illustrated in FIG. 6 and the local resources information stored in the HDD 102 are included.

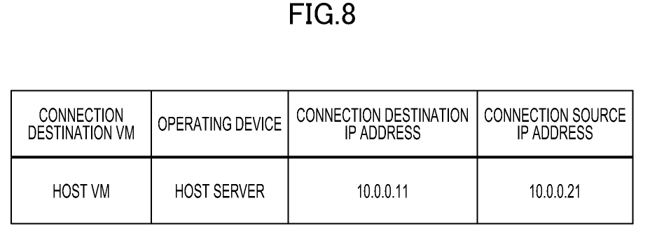

FIG. 8 illustrates an example of a record layout of a connection table. The resources management unit 21 is configured to store the connection table in an HDD and manage connection information on the basis of the stored connection table. The connection table includes IP addresses respectively allocated to the management OS concerned and the VM concerned and information indicative of an operating device in which the management OS and the VM are operated. In the example illustrated in FIG. 8, the IP address “10.0.0.11” allocated to the host VM 13 which is operated in the host server 1 is included. In the case that the connection information has been received from the host management OS, the resources management unit 21 acquires the IP address allocated to the terminal VM 33 from the connection information and stores the acquired IP address in the connection table corresponding to the host VM 13 of a connection destination. In the example illustrated in FIG. 8, the IP address “10.0.0.21” of the terminal VM 33 is acquired as the IP address of a connection source and is stored in the connection table so as to correspond to the host VM 13.

Next, summary of this embodiment will be described. In the case that the client terminal 3 has detected connection of a physical device, the host VM 13 which is allocated to the client terminal 3 concerned is moved to the client terminal 3 concerned. Then, the physical device is allocated to the host VM 13 which has been moved to the client terminal 3. The host VM 13 gains access to the physical device which is connected to the client terminal 3 via the terminal VMM 31. Next, details thereof will be described.

In the case that the physical device has been connected to the client terminal 3, the input/output unit 306 included in the client terminal 3 sends a notification that the physical device has been connected to the physical device connection detecting unit 311 included in the terminal management OS 32. The physical device connection detecting unit 311 detects the physical device which has been freshly connected to the client terminal on the basis of the notification sent from the input/output unit 306 and sends a notification that connection of the physical device has been detected (hereinafter, referred to as the connection notification) to the terminal management OS 32. The terminal management OS 32 which has received the connection notification transmits the received connection notification to the management server 2. The management server 2 which has received the connection notification specifies one host VM 13 to which the terminal VM 33 concerned is remote-connected from the host VMs 13 operated in the plurality of host servers 1. The management server 2 judges whether move of the specified host VM 13 to the client terminal 3 concerned is possible on the basis of the resources information managed using the resource management unit 21.

Whether move is possible is judged depending on whether first to third judging conditions which will be described herein below are met. As the first judging condition, the management server 2 judges whether the CPU type name of the host server 1 coincides with the CPU type name of the client terminal 3. As the second judging condition, the management server 2 judges whether the used memory capacity of the host VM 13 is equal to or less than the free memory capacity of the client terminal 3. As the third judging condition, the management server 2 judges whether the number of used cores of the host VM 13 coincides with the number of used cores of the client terminal 3, that is, the number of used cores of the terminal management OS 32. In the case that all the first to third judging conditions have been judged to be met, the management server 2 judges that the move is possible.

In the case that the move has been judged to be possible, the management server 2 sends a request to move the host VM 13 (hereinafter, referred to as the move request) to the host server 1. The host management OS 12 of the host server 1 which has received the move request forbids other VMs to use the resources that the host VM 13 uses and reserves the resources. The host management OS 12 sends a request to deallocate the basic input/output device from the host VM 13 (hereinafter, referred to as the deallocation request) to the host VMM 11 using the physical device allocation requesting unit 123. The host VMM 11 which has accepted the deallocation request deallocates the basic input/output device from the host VM 13 using the physical device allocating unit 112. The host management OS 12 moves the host VM 13 from which the basic input/output device has been deallocated to the client terminal 3 using the VM moving unit 122.

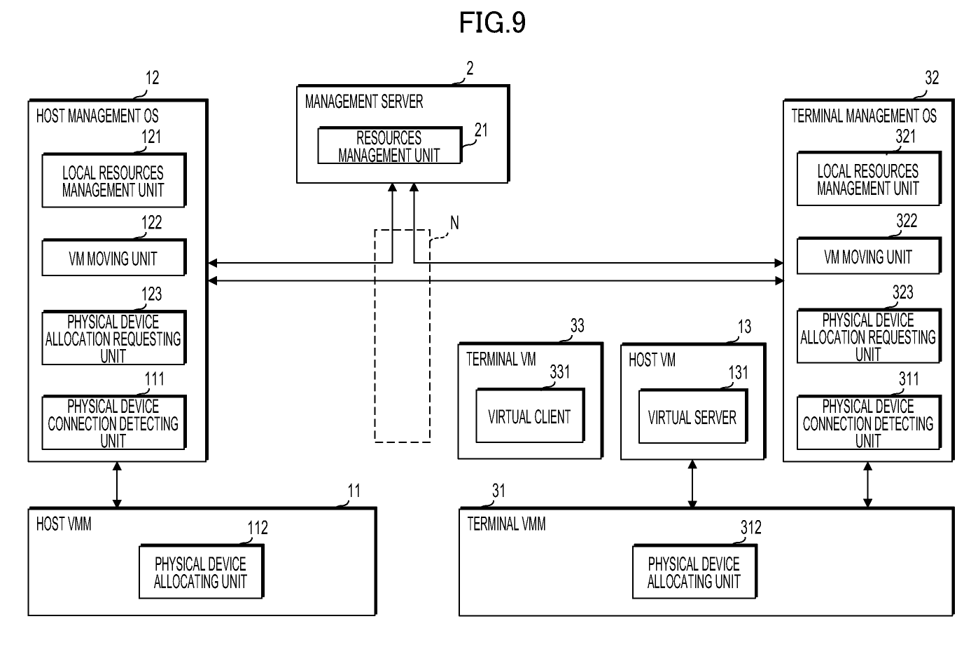

FIG. 9 is an example of a functional configuration of each device. FIG. 9 illustrates an example of a functional configuration of each device used in the case that the host VM 13 has been moved from the host server 1 to the client terminal 3. In the example illustrated in FIG. 9, the host VM 13 which has been moved from the host server 1 to the client terminal 3 is operated in accordance with the terminal VMM 31. In the case that move of the host VM 13 has been completed, the host management OS 12 sends a request to deallocate the basic input/output device of the client terminal 3 from the terminal VM 33 to the terminal management OS 32. The terminal management OS 32 which has received the deallocation request requests the terminal VMM 31 to deallocate the basic input/output device from the terminal VM 33 using the physical device allocation requesting unit 323.

The terminal management OS 32 also requests the terminal VMM 31 to allocate one physical device which has been freshly connected to the client terminal 3 to the host VM 13 using the allocation requesting unit 323, in addition to the request to deallocated the basic input/output device. The terminal VMM 31 deallocates the basic input/output device from the terminal VM 33 and allocates the freshly connected physical device to the host VM 13 using the physical device allocating unit 312. As illustrated in FIG. 9, the host VM 13 turns accessible to the physical device which has been connected to the client terminal 3 with no interposition of the network N. Next, an operation executed in the case that the physical device has been disconnected from the client terminal 3 to return the host VM 13 to the host server 1 which is the move source will be described.

In the case that the physical device has been disconnected from the client terminal 3, the input/output unit 306 included in the client terminal 3 sends a notification that the physical device has been disconnected to the physical device connection detecting unit 311 included in the terminal management OS 32. The physical device connection detecting unit 311 detects the freshly disconnected physical device on the basis of the notification sent from the input/output unit 306 and sends a notification that disconnection of the physical device has been detected to the terminal management OS 32. The terminal management OS 32 which has received the notification that disconnection of the physical device has been detected sends a request to deallocate the basic input/output device of the client terminal 3 and the physical device from the host VM 13 to the terminal VMM 31 using the physical device allocation requesting unit 323. The terminal VMM 31 which has received the deallocation request deallocates the basic input/output device and the physical device from the host VM 13 using the physical device allocating unit 312. The terminal management OS 32 sends a request to allocate the basic input/output device of the client terminal 3 to the terminal VM 33 to the terminal VMM 31 using the physical device allocation requesting unit 323. The terminal VMM 31 which has received the allocation request allocates the basic input/output device to the terminal VM 33. The terminal management OS 332 moves the host VM 13 back to the host server 1 which is the move source using the VM moving unit 322.

In the case that move of the host VM 13 has been completed, the terminal management OS 32 sends a request to allocate the basic input/output device of the host server 1 to the host VM 13 to the host management OS 12. The host management OS 12 which has received the allocation request sends a request to allocate the basic input/output device to the host VM 13 to the host VMM 11 using the physical device allocation requesting unit 123. The host VMM 11 which has received the allocation request allocates the basic input/output device of the host server 1 to the host VM 13 using the physical device allocating unit 112 to complete the operation of returning the host VM 13 to the host server 1.

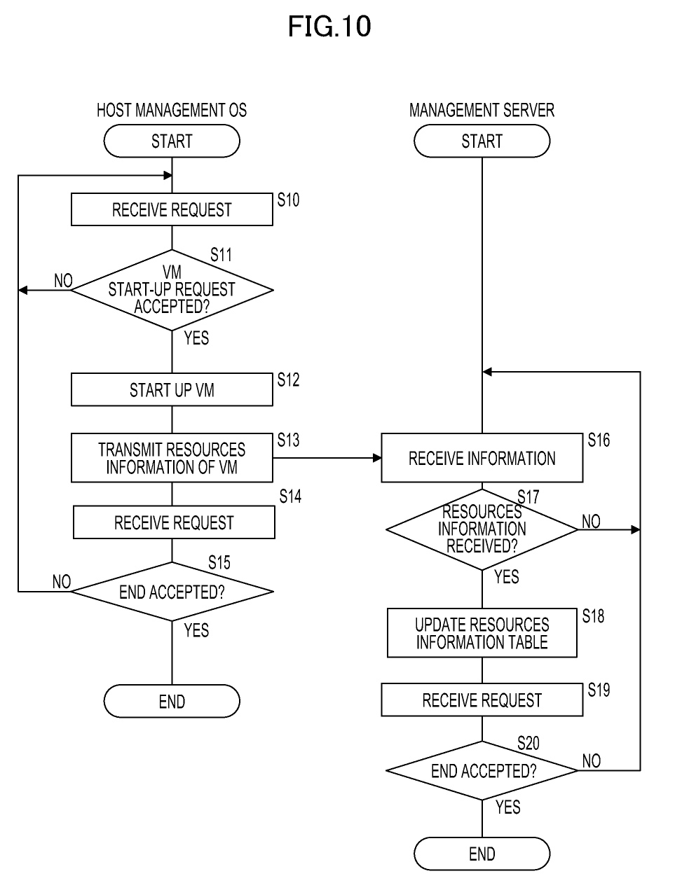

FIG. 10 illustrates processing of a VM starting-up process. The VM starting-up process is executed using the host management OS 12 so as to transmit the resources information to the management server 2. The VM starting-up process is executed in the case that the host management OS 12 has received a request to start up the host VM 13. The request to start up the host VM 13 may be received by the host server 1, for example, on the basis of an operation by the user. The host management OS 12 receives a request (step S10) and judges whether the request to start up the VM has been accepted (step S11). In the case that the request to start up the VM has been judged not to be accepted (NO at step S11), the host management OS 12 returns the process to step S10 for receiving a request. In the case that the request to start up the VM has been judged to be accepted (YES at step S11), the host management OS 12 starts up the VM (step S12).

The host management OS 12 transmits the resources information of the started-up VM to the management server 2 (step S13). The management server 2 receives information transmitted from the host management OS 12 (step S16) and judges whether the resources information has been received (step S17). In the case that the resources information has been judged not to be received (NO at step S17), the management server 2 returns the process to step S16 for receiving information. In the case that the resources information has been judged to be received (YES at step S17), the management server 2 updates the resources information table using the received resources information (step S18). The management server 2 receives a request (step S19) and judges whether end of execution of the process by shutdown has been accepted (step S20). In the case that the end of execution of the process has been judged not to be accepted (NO at step S15), the management server 2 returns the process to step S16 for receiving a request.

In the case that the end of execution of the process has been judged to be accepted (YES at step S20), the management server 2 terminates execution of the VM starting-up process. Then, the host management OS 32 receives a request (step S14) and judges whether end of execution of the process by shutdown has been accepted (step S15). In the case that the end of execution of the process has been judged not to be accepted (NO at step S15), the host management OS 32 returns the process to step S10 for receiving a request. In the case that the end of execution of the process has been judged to be accepted (YES at step S15), the host management OS 32 terminates execution of the VM starting-up process. The VM starting-up process is also executed so as to start up the terminal VM 33 using the terminal management OS 32 in the case that the terminal management OS 32 has accepted the request to start up the terminal VM 33. A VM starting-up process executed using the terminal management OS 32 is the same as that of the flowchart illustrated in FIG. 10 and hence description thereof will be omitted.

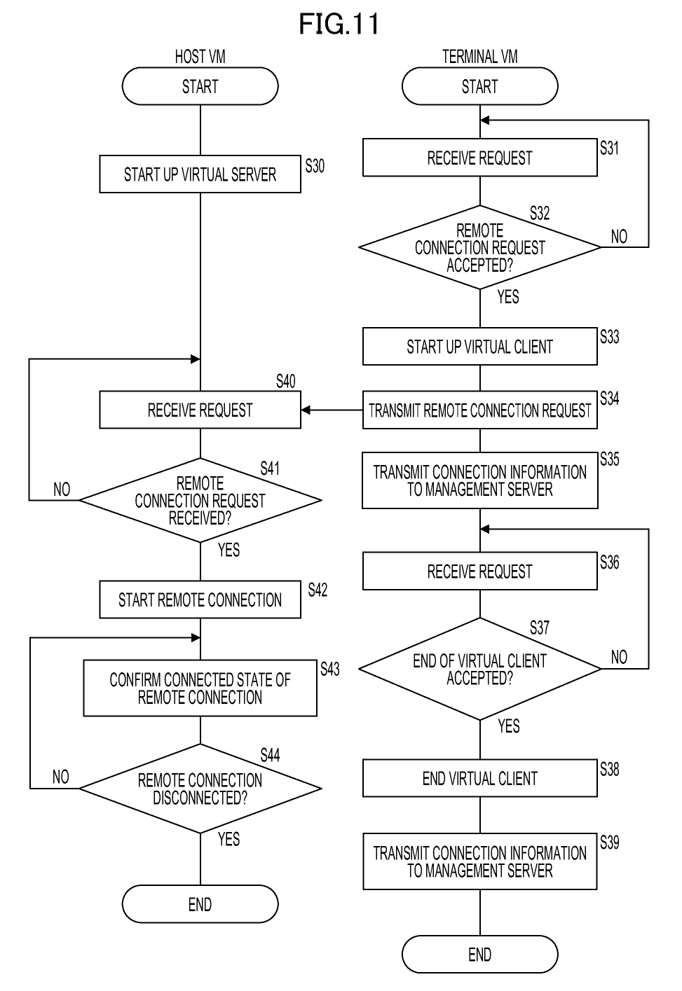

FIG. 11 illustrates processing of a remote connecting process. The remote-connecting process is executed using the host VM 13 and the terminal VM 33. The host VM 13 starts up the virtual server 131 (step S30). The terminal VM 33 receives a request (step S31) and judges whether a request for remote connection has been accepted (step S32). In the case that the request for remote connection has been judged not to be accepted (NO at step S32), the terminal VM 33 return the process to step S31 for receiving a request. In the case that the request for remote connection has been judged to be accepted (YES at step S32), the terminal VM 33 starts up the virtual client 331 (step S33).

The terminal VM 33 transmits the request for remote connection to the host VM 13 (step S34). Then, the terminal VM 33 transmits connection information including the IP address and the connected state of the host VM 13 of a connection destination to the management server 2 (step S35). The terminal VM 33 receives a request (step S36) and judges whether end of operation of the virtual client 331 has been accepted (step S37). In the case that the end of operation of the virtual client 331 has been judged not to be accepted (NO at step S37), the terminal VM 33 returns the process to step S36 for receiving a request. In the case that the end of operation of the virtual client 331 has been judged to be accepted (YES at step S37), the terminal VM 33 terminates the operation of the virtual client 331 (step S38). The terminal VM 33 transmits connection information including the IP address and disconnected state of the host VM 13 to the management server 2 (step S39) and terminates execution of the remote-connecting process.

The host VM 13 receives a request (step S40) and judges whether a request for remote connection sent from the terminal VM 33 has been received (step S41). In the case that the request for remote connection has been judged not to be received (NO at step S41), the host VM 13 returns the process to step S40 for receiving a request. In the case that the request for remote connection has been judged to be received (YES at step S41), the host VM 13 starts remote connection (step S42). The host VM 13 confirms the connected state of remote connection (step S43) and judges whether the remote connection has been disconnected (step S44). In the case that the remote connection has been judged not to be disconnected (NO at step S44), the host VM 13 returns the process to step S43 for confirming the connected state of the remote connection. In the case that the remote connection has been judged to be disconnected (YES at step S44), the host VM 13 terminates execution of the remote-connecting process.

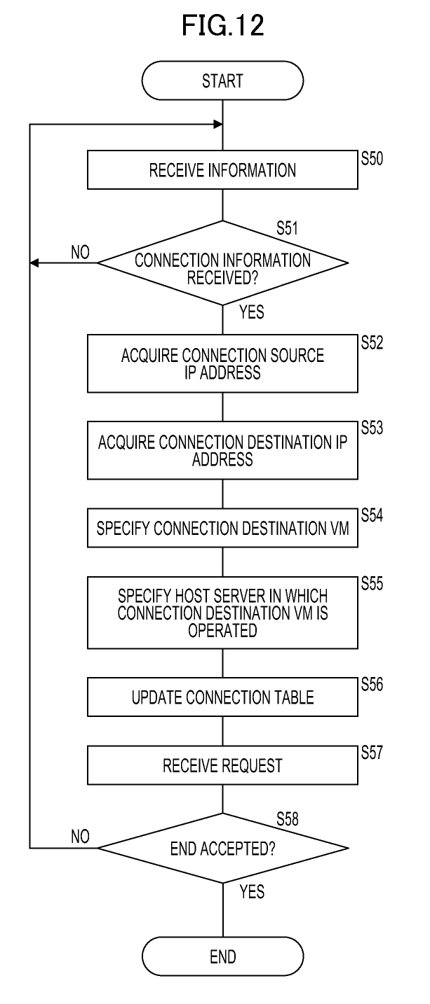

FIG. 12 illustrates processing of a connection table updating process. The connection table updating process is executed using a CPU not illustrated in the case that the management server 2 has received the connection information. The CPU of the management server 2 receives information (step S50) and judges whether the connection information has been received (step S51). In the case that the connection information has been judged not to be received (NO at step S51), the CPU returns the process to step S50 for receiving information. In the case that the connection information has been judged to be received (YES at step S51), the CPU acquires the IP address of the transmission source as the IP address of the connection source (step S52). The CPU acquires the IP address of the connection destination included in the connection information (step S53) to specify the connection destination VM (step S54).

The CPU refers to the resources information table and specifies one host server 1 in which the connection destination VM is operated (step S55). The CPU updates the connection table by using the IP address of the connection source, the name indicative of the specified connection destination VM, the IP address of the connection destination and the name of the specified host server 1 (step S56). The CPU receives a request (step S57) and judges whether end of execution of the process has been accepted (step S58). In the case that the end of execution of the process has been judged not to be accepted (NO at step S58), the CPU returns the process to step S50 for receiving information. In the case that the end of execution of the process has been judged to be accepted (YES at step S58), the CPU terminates execution of the connection table updating process.

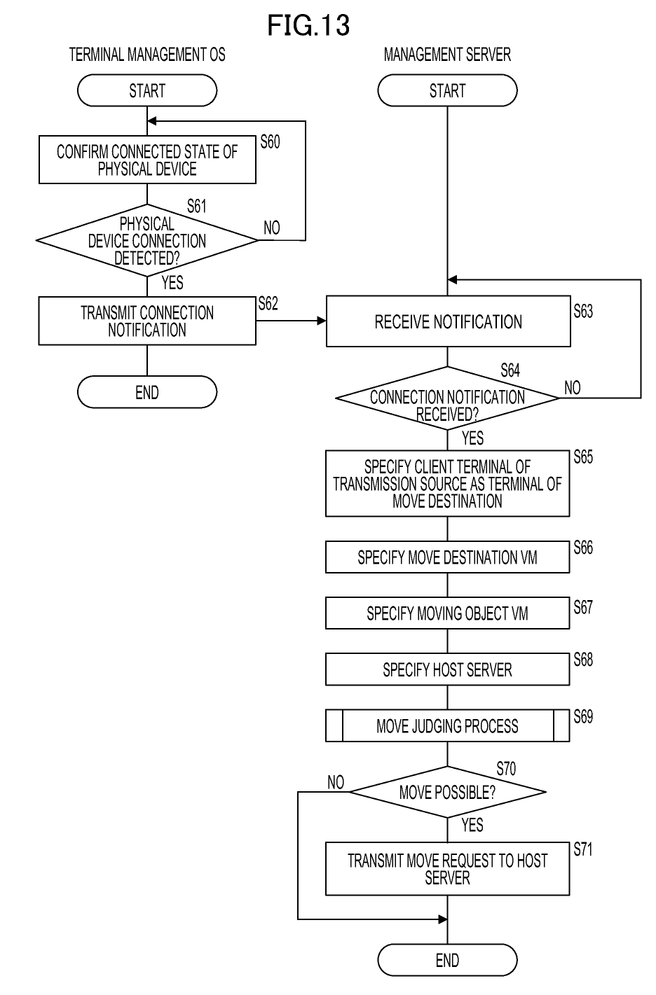

FIG. 13 illustrates processing of a move requesting process. The move requesting process is executed using the terminal management OS 32 and the management server 2 in the case that the terminal management OS 32 has detected a physical device which has been freshly connected to the client terminal 3. The terminal management OS 32 confirms the connected state of the physical device (step S60) and judges whether connection of the physical device has been detected (step S61). In the case that the connection of the physical device has been judged not to be detected (NO at step S61), the terminal management OS 32 returns the process to step S60 for confirming the connected state of the physical device. In the case that the connection of the physical device has been judged to be detected (YES at step S61), the terminal management OS 32 transmits a notification that the physical device has been connected (hereinafter, referred to as a connection notification) to the management server 2 (step S62) and terminates execution of the move requesting process.

The CPU of the management server 2 receives a notification (step S63) and judges whether the connection notification sent from the terminal management OS 32 has been received (step S64). In the case that the connection notification has been judged not to be received (NO at step S64), the CPU of the management server 2 returns the process to step S63 for receiving a notification. In the case that the connection notification has been judged to be received (YES at step S64), the CPU of the management server 2 acquires the IP address of a transmission source to specify one client terminal 3 as the move destination terminal (step S65). The CPU of the management server 2 refers to the resources information table and specifies one terminal VM 33 which is operated in the move destination terminal as the move destination VM (step S66). The CPU of the management server 2 refers to the connection table and specifies one host VM 13 to which the move destination VM is remote-connected as the moving object VM (step S67).

The CPU of the management server 2 refers to the resources information table and specifies one host server 1 in which the moving object VM is operated (step S68). The CPU of the management server 2 executes a move judging process which will be described later (step S69). The CPU of the management server 2 judges whether move is possible as a result of execution of the move judging process (step S70). In the case that the move has been judged to be impossible (NO at step S70), the CPU of the management server 2 terminates execution of the move requesting process. In the case that the move has been judged to be possible (YES at step S70), the CPU of the management server 2 transmits a move request to the host management OS 12 of the host server 1 (step S71) and terminates execution of the move requesting process.

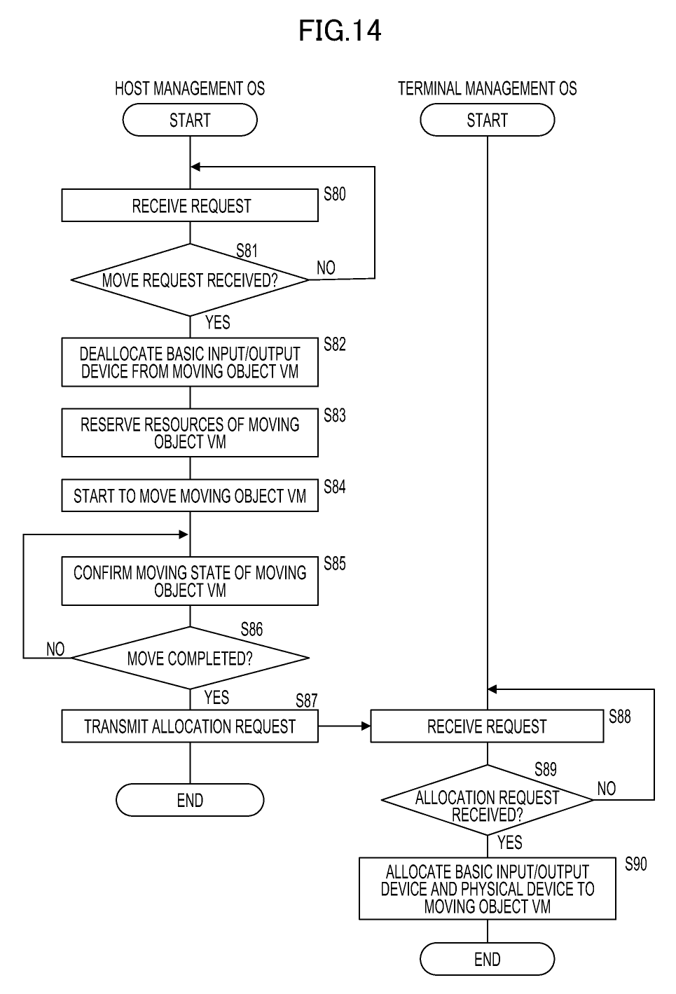

FIG. 14 illustrates processing of a moving process. The moving process is executed using the host management OS 12 and the terminal management OS 32 in the case that the host management OS 12 has accepted the move request transmitted as a result of execution of the move requesting process. The host management OS 12 receives a request (step S80) and judges whether the move request has been received (step S81). In the case that the move request has been judged not to be received (NO at step S81), the terminal management OS 32 returns the process to step S80 for receiving a request. In the case that the move request has been judged to be received (YES at step S81), the host management OS 12 deallocates the basic input/output device from the host VM 13 which is the moving object VM (step S82). The host management OS 12 reserves the resources that the moving object VM uses (step S83).

The host management OS 12 starts to move the moving object VM to the host server 1 (step S84). The host management OS 12 confirms the moving state of the moving object VM (step S85) and judges whether move has been completed (step S86). In the case that the move has been judged not to be completed (NO at step S86), the host management OS 12 returns the process to step S85 for confirming the moving state of the moving object VM. In the case that the move has been judged to be completed (YES at step S86), the host management OS 12 transmits an allocation request to the terminal management OS 32 (step S87) and terminates execution of the moving process.

The terminal management OS 32 of the client terminal 3 receives a request (step S88) and judges whether the allocation request has been received from the host management OS 12 of the host server 1 (step S89). In the case that the allocation request has been judged not to be received (NO at step S89), the terminal management OS 32 returns the process to step 88 for receiving a request. In the case that the allocation request has been judged to be received (YES at step S89), the terminal management OS 32 allocates the basic input/output device and the physical device to the moving object VM which has been moved to the host server 1 (step S90) and terminates execution of the moving process.

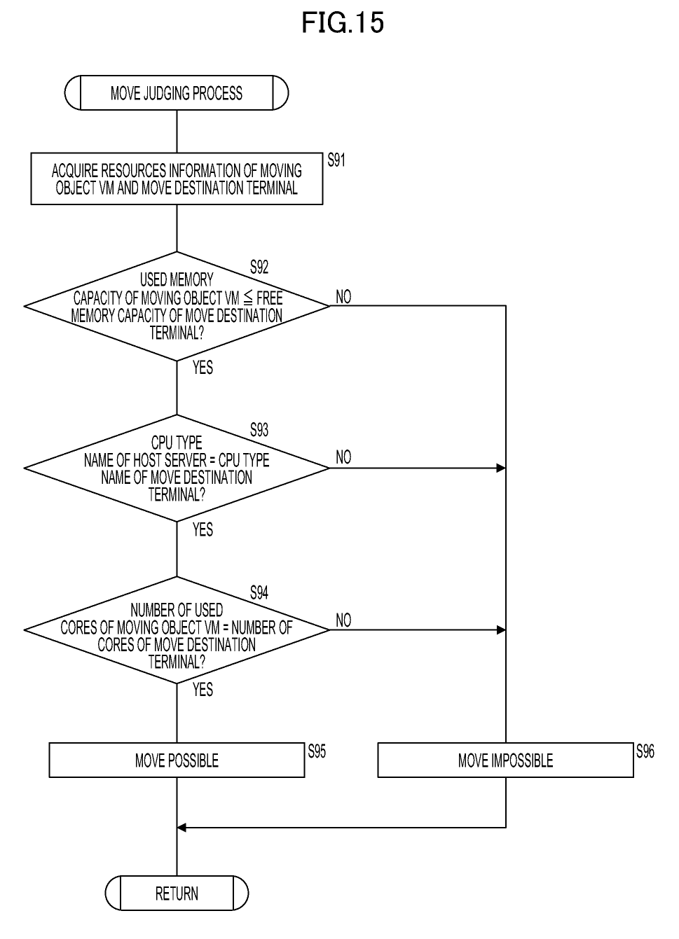

FIG. 15 illustrates processing of the move judging process. The move judging process is executed using the CPU of the management server 2 at step S69 of the flowchart illustrated in FIG. 13. The CPU of the management server 2 acquires the resources information of the moving object VM and the move destination terminal from the resources information table (step S91). Incidentally, the resources information of the move destination terminal is acquired by referring to the resources information of the move destination VM included in the resources information table. The CPU of the management server 2 judges whether the used memory capacity of the moving object VM is equal to or less than the free memory capacity of the move destination terminal (the client terminal 3) (step S92).

In the case that the used memory capacity of the moving object VM has been judged not to be equal to or less than the free memory capacity (NO at step S92), the CPU of the management server 2 judges that the move is impossible (step S96) and terminates execution of the move judging process. In the case that the used memory capacity of the moving object VM has been judged to be equal to or less than the free memory capacity (YES at step S92), the CPU of the management server 2 judges whether the CPU type name of the move source host server 1 coincides with the CPU type name of the move destination terminal (step S93). In the case that the CPU type names have been judged not to coincide with each other (NO at step S93), the CPU of the management server 2 shifts the process to step S96 for judging that the move is impossible.

In the case that the CPU type names have been judged to coincide with each other (YES at step S93), the CPU of the management server 2 judges whether the number of used cores of the moving object VM coincides with the number of cores of the move destination terminal (step S94). In the case that the number of used cores of the moving object VM has been judged not to coincide with the number of cores of the move destination terminal (NO at step S94), the CPU of the management server 2 shifts the process to step S96 for judging that the move is impossible. In the case that the number of used cores of the moving object VM has been judged to coincide with the number of cores of the move destination terminal (YES at step S94), the CPU of the management server 2 judges that the move is possible (step S95) and terminates execution of the move judging process.

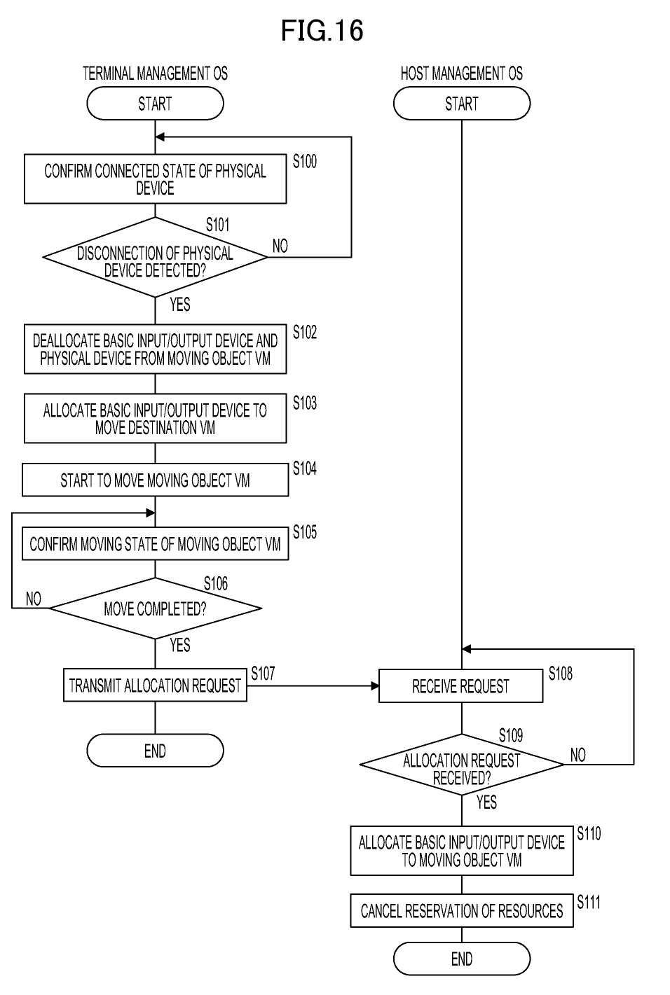

FIG. 16 illustrates processing of a returning process. The returning process is executed in order to return the moving object VM to the host server 1 after the physical device has been disconnected from the client terminal 3. The terminal management OS 32 of the client terminal 3 confirms the connected state of the physical device concerned (step S100) and judges whether disconnection of the physical device from the client terminal 3 has been detected (step S101). In the case that the disconnection of the physical device has been judged not to be detected (NO at step S101), the terminal management OS 32 returns the process to step S100 for confirming the connected state of the physical device. In the case that the disconnection of the physical device has been judged to be detected (YES at step S101), the terminal management OS 32 deallocates the basic input/output device and the physical device from the host VM 13 of the moving object VM (step S102).

The terminal management OS 32 allocates the basic input/output device to the terminal VM 33 of the move destination VM (step S103). The terminal management OS 32 starts to move the host VM 13 of the moving object VM to the host server 1 (step S104). The terminal management OS 32 confirms the moving state of the moving object VM (step S105) and judges whether the move has been completed (step S106). In the case that the move has been judged not to be completed (NO at step S106), the terminal management OS 32 returns the process to step S105 for confirming the moving state of the moving object VM. In the case that the move has been judged to be completed (YES at step S106), the terminal management OS 32 transmits a device allocation request to the host management OS 12 (step S107) and terminates execution of the returning process.

The host management OS 12 of the hot server 1 receives a request (step S108) and judges whether the allocation request sent from the terminal management OS 32 has been received (step S109). In the case that the allocation request has been judged not to be received (NO at step S109), the host management OS 12 returns the process to step S108 for receiving a request. In the case that the allocation request has been judged to be received (YES at step S109), the host management OS 12 allocates the basic input/output device to the host VM 13 of the moving object VM which has been moved back to the host server 1 (step S110). The host management OS 12 cancels reservation of the resources of the moving object VM (step S111) and terminates execution of the returning process.

In the case that the host VM 13 intends to utilize a freshly connected physical device, owing to the above mentioned operations, it may become possible to move the host VM 13 to the client terminal 3 to gain access to the physical device concerned with no interposition of the network N. In the case that utilization of the physical device has been finished, remote operation of the host VM 13 from the client terminal 3 may become possible after the host VM 13 has been moved back to the move source host server 1.

In the embodiment 1, although an example in which a physical device is freshly connected to the client terminal 3 has been described, the embodiment is not limited to the above example and the embodiment may be also applied to a case in which, for example, a physical device has been freshly connected to each of the plurality of host servers 1. In the latter case, one host VM 13 to which one client terminal 3 is remote-connected may be moved to another host server 1 from which the freshly connected physical device has been detected. Also in the embodiment 1, although the computer system with the management server 2 has been illustrated, the embodiment is not limited to the system of the above mentioned type. That is, the resources management unit 21 is not included in the management server 2 and may be included in one host management OS 12 which is operated in any one of the plurality of host servers 1 instead. In the latter case, the host management OS 12 may function as a judging unit that executes the move judging process.

Further in the embodiment 1, although an example of using a hypervisor type VMM in which the VMMs are operated using the hardware as illustrated in FIG. 2A and FIG. 2B and various programs such as the management OSs and the VMs are operated on the basis of the VMMs concerned has been described, the embodiment is not limited to the above mentioned example and, for example, a host OS type VMM in which a host OS is operated using hardware and a management OS and a VMM are operated on the basis of the host OS concerned may be used.

### Embodiment 2

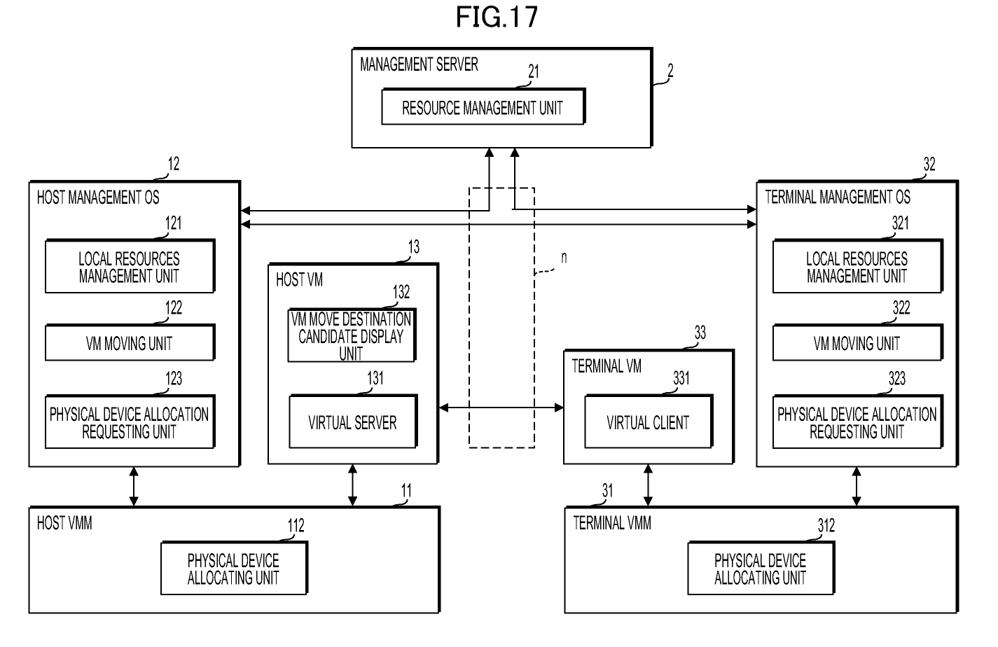

FIG. 17 illustrates an example of a functional configuration of each device. The embodiment 1 is configured to move one host VM to one client terminal to which one physical device has been freshly connected. On the other hand, the embodiment 2 is configured to move one host VM to one client terminal having one client terminal selected by a user. In the embodiment 2, the host VM 13 includes a VM move destination candidate display unit 132 serving as a display unit that displays client terminals 3 including usable physical devices as candidates for a destination to which the VM is to be moved together with the physical device included therein. The VM move destination candidate display unit 132 may be provided, for example, by executing a program on the basis of an OS which is operated in accordance with the host VM 13. The VM move destination candidate display unit 132 displays move destination candidates and physical devices included therein to the user of the terminal VM 33 which is remote-connected to the host VM 13. The host VM 13 functions as an operation accepting unit that accepts an operation of selecting one move destination terminal and its physical device to be used from the move destination candidates and physical devices included therein from the terminal VM 33. The host VM 13 also functions as a selecting unit that selects a physical device on the basis of the accepted operation.

Next, summary of the embodiment 2 will be described. The host VM 13 which is remote-connected to the terminal VM 33 via the client terminal 3 accepts a request to use a physical device from the user of the client terminal 3. The host VM 13 which has accepted the request to use a physical device displays a list of physical devices connected to client terminals 3 move of the host VM to which is possible using the VM move destination candidate display unit 132. The host VM 13 accepts selection of one client terminal 3 from the user. The host VM 13 is moved to the selected client terminal 3. The host VM 13 which has been moved to the selected client terminal 3 gains access to a physical device which is connected to the client terminal 3 via the terminal VMM 31. Details of the above mentioned operations will be described herein below.

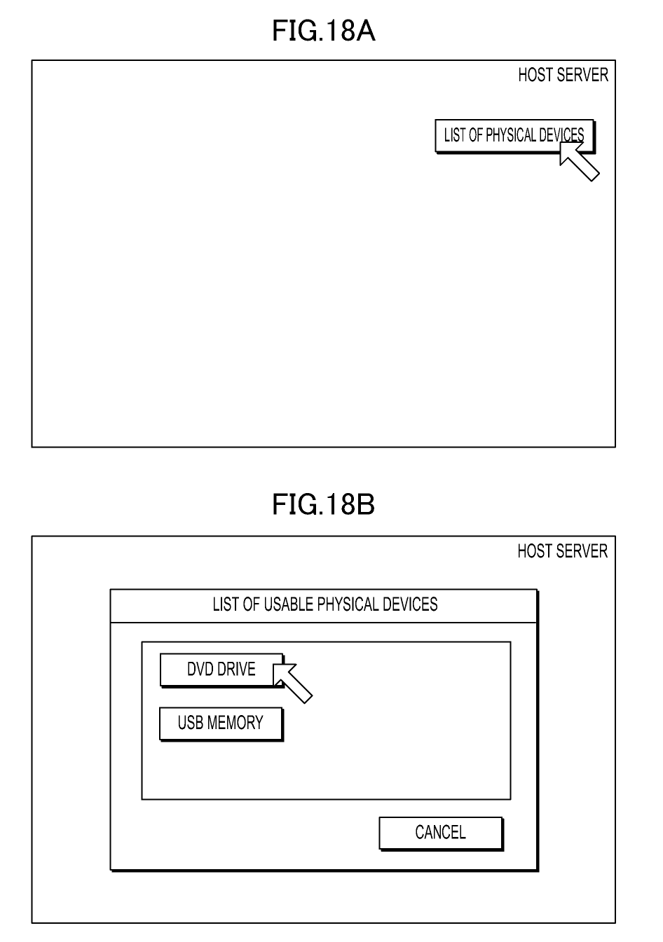

FIG. 18A and FIG. 18B illustrate examples of screens for selecting a physical device. FIG. 18A and FIG. 18B respectively illustrate desktop screens on which a list button (FIG. 18A) and a selection window (FIG. 18B) are respectively displayed. The host VM 13 operates to display the list button used to accept an instruction to display the list of physical devices on the desktop screen displayed on the client terminal 3. In the example illustrated in FIG. 18A, the list button entitled “List of Physical Devices” is displayed on an upper right part of the desktop screen. A cursor operated by the user is situated on the list button.

In the case that the list button has been clicked, the host VM 13 requests the management server 2 to display the list of usable physical devices using the VM move destination candidate display unit 132. The management server 2 acquires move destination terminals move of the host VM 13 to which is possible on the basis of the resources information of the host VM 13 and the resources information of each client terminal 3 and then acquires the physical devices connected to the move destination terminals move of the host VM 13 to which is possible in the form of the list of usable physical devices. Then, the management server 2 transmits the list of physical devices and their corresponding move destination terminals move of the host VM to which is possible to the host VM 13 of the request source. The host VM 13 displays the selection window used to accept selection of one physical device and one move destination terminal on the desktop screen on the basis of the list acquired from the management server 2.

In the example illustrated in FIG. 18B, the selection window entitled “List of Usable Physical Devices” is displayed on the desktop screen. In the example illustrated in FIG. 18B, device buttons respectively corresponding to a DVD drive and an USB memory and a cancel button are being displayed on the selection window. In the case that the cancel button has been clicked, the host VM 13 closes the selection window. In the example illustrated in FIG. 18B, a cursor which has been operated by the user is situated on the device button corresponding to the DVD drive in the physical device window.

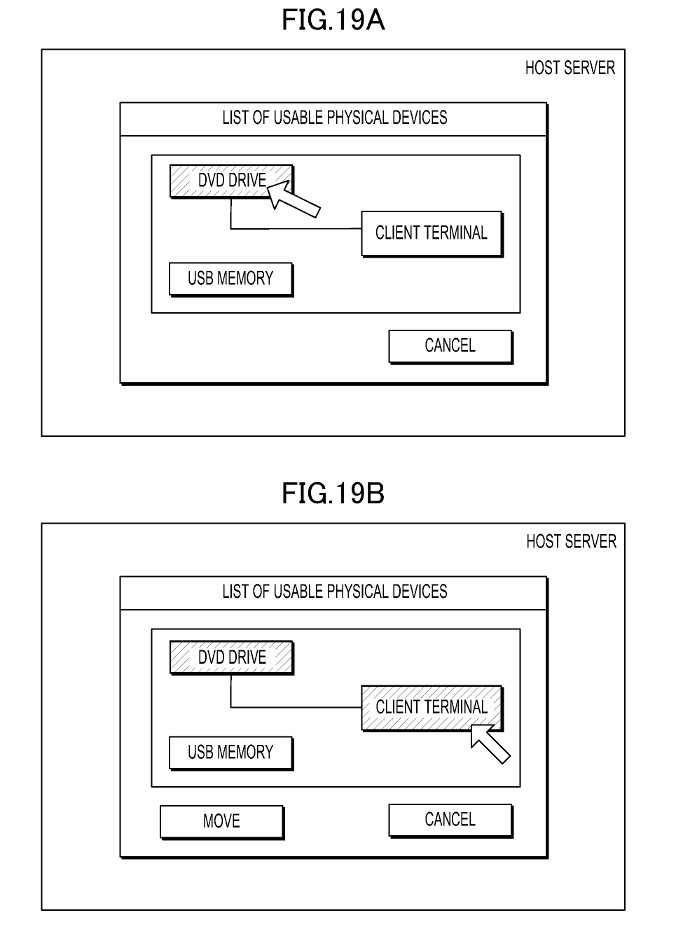

FIG. 19A and FIG. 19B illustrate examples of screens for selecting one move destination terminal. FIG. 19A and FIG. 19B illustrates the examples of desktop screens respectively displayed when the device button (FIG. 19A) and a move destination button (FIG. 19B) have been selected. In the case that the device button has been clicked, the host VM 13 acquires one client terminal 3 to which the physical device corresponding to the device button concerned is connected. Then, the host VM 13 displays the move destination button corresponding to the client terminal 3 on the selection window. In the example illustrated in FIG. 19A, the device button corresponding to the selected DVD drive is being reversely displayed as illustrated by the shaded portion. In addition, the move destination button corresponding to the client terminal 3 to which the selected DVD drive is connected and entitled “Client Terminal” is being displayed.

In addition, a line connecting together the device button and the move destination button is being displayed. This line indicates that the DVD drive is connected to the client terminal 3. Alternatively, the location of each client terminal 3 may be displayed on the selection window. The location of each client terminal 3 may be acquired from the resources information that the resources management unit 21 of the management server 2 manages. In the case that one move destination button has been clicked and selected, the host VM 13 displays a move button on the selection window. In the case that the move button has been clicked, the host VM 13 acquires the client terminal 3 corresponding to the selected move destination button as the move destination terminal. In the example illustrated in FIG. 19B, the move destination button corresponding to the client terminal 3 is clicked and is being reversely displayed and the move button is being displayed. The host VM 13 notifies the host management OS 12 of the acquired move destination terminal. Then, the host management OS 12 moves the host VM 13 to the move destination terminal.

The operation of moving the host VM 13 to the move destination terminal and the operation of allocating a physical device to the host VM 13 after moved are the same as those in the embodiment 1 and hence description thereof will be omitted. In the case that the move destination terminal has been acquired, the host VM 13 may display a confirmation window for confirming whether the host VM 13 is to be moved on the desktop screen. In the above mentioned case, a confirmation button and a move cancel button may be displayed on the confirmation window together with a message that urges the user to confirm whether the host VM 13 is to be moved. In the case that the confirmation button has been clicked, the host VM 13 is moved to the move destination terminal. In the case that the move cancel button has been clicked, the host VM 13 may return the process to selection of the move destination terminal using the selection window.

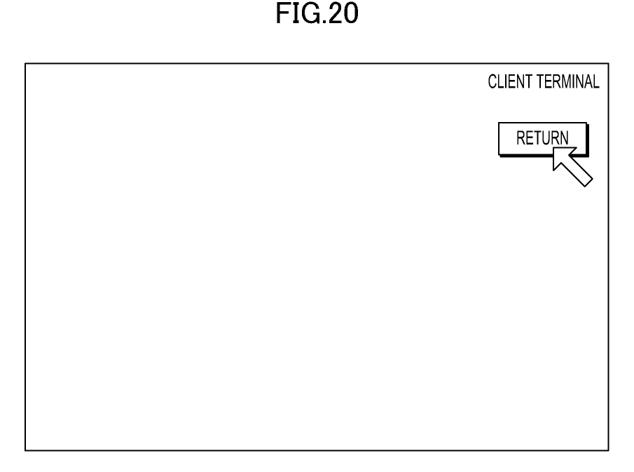

FIG. 20 illustrates an example of a screen for accepting a return instruction. In the case that the host VM 13 has been moved to the move destination terminal, the host VM 13 operates to display a return button to be clicked to accept the return instruction on which the host VM 13 is moved back to the host server 1 on the desktop screen. In the example illustrated in FIG. 20, the return button entitled “Return” is displayed on an upper right part in the desktop screen. In the case that the return button has been clicked, the host VM 13 sends a request to move the host VM 13 back to the host server 1 to the terminal management OS 32. Then, the terminal management OS 32 starts to move the host VM 13 back to the host server 1.

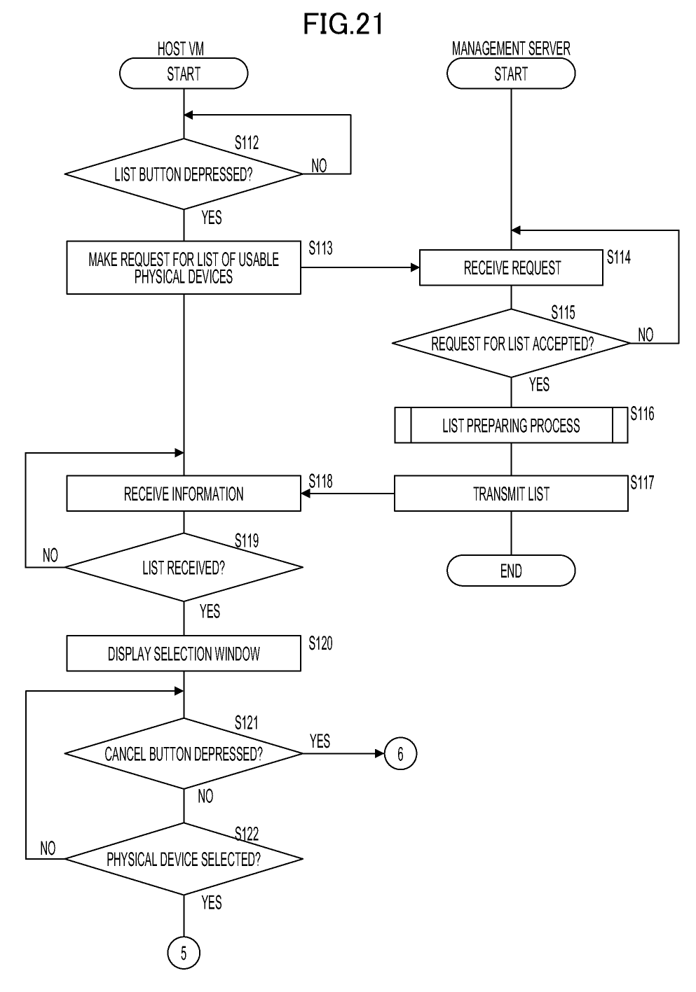

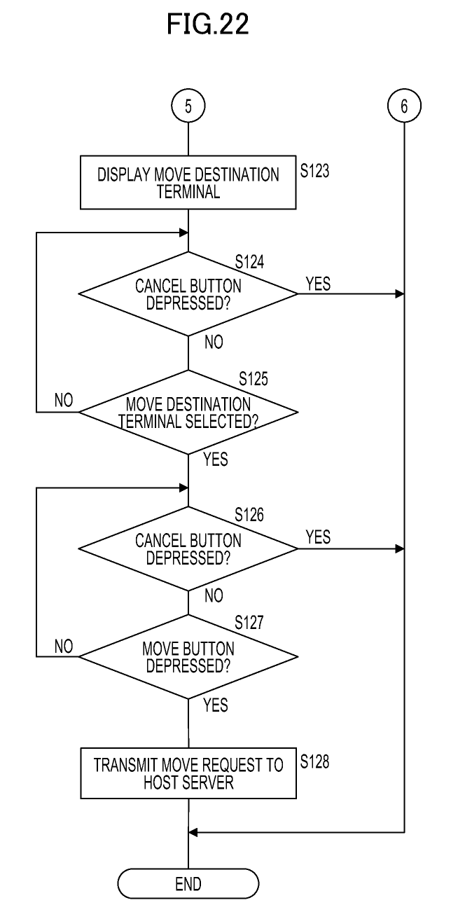

FIGS. 21 and 22 illustrate processing of a move destination terminal selecting process. In the move destination terminal selecting process, selection of the move destination terminal is executed by accepting clicking of the list button. The icon host VM 13 judges whether the list button has been depressed (step S112). In the case that the list button has been judged not to be depressed (NO at step S112), the host VM 13 waits until the list button is depressed. In the case that the list button has been judged to be depressed (YES at step S112), the host VM 13 transmits a list request, that is, a request to display the list of usable physical devices to the management server 2 (step S113). The management server 2 receives a request (step S114) and judges whether the list request sent from the host VM 13 has been accepted (step S115).

In the case that the list request has been judged not to be accepted (NO at step S115), the management server 2 returns the process to step S114 for receiving a request. In the case that the list request has been judged to be accepted (YES at step S115), the management server 2 executes a list preparing process which will be described later (step S116). The management server 2 transmits the prepared list to the host VM 13 (step S117). The host VM 13 receives information (step S118) and judges whether the list sent from the management server 2 has been received (step S119). In the case that the list has been judged not to be received (NO at step S119), the host VM 13 returns the process to step S118 for receiving information.

In the case that the list has been judged to be received (YES at step S119), the host VM 13 displays a selection window including the list on the desktop screen (step S120). Then, the host VM 13 judges whether the cancel button has been depressed (step S121). In the case that the cancel button has been judged to be depressed (YES at step S121), the host VM 13 terminates execution of the move destination terminal selecting process. In the case that the cancel button has been judged not to be depressed (NO at step S121), the host VM 13 judges whether one physical device has been selected from the physical devices in the list displayed on the selection window (step S122).

In the case that it has been judged that any physical device is not selected (NO at step S122), the host VM 13 returns the process to step S121 for judging whether the cancel button has been depressed (step S122). In the case that it has been judged that one physical device has been selected (YES at step S122), the host VM 13 displays the move destination terminals on the selection window (step S123). Then, the host VM 13 judges whether the cancel button has been depressed (step S124). In the case that the cancel button has been judged to be depressed (YES at step S124), the host VM 13 terminates execution of the move destination selecting process.

In the case that the cancel button has been judged not to be depressed (NO at step S124), the host VM 13 judges whether one move destination terminal has been selected from the move destination terminals displayed on the selection window (step S125). In the case that it has been judged that any move destination terminal is not selected (NO at step S125), the host VM 13 returns the process to step S124 for judging whether the cancel button has been depressed. In the case that it has been judged that one move destination terminal has been selected (YES at step S125), the host VM 13 judges whether the cancel button has been depressed (step S126). In the case that the cancel button has been judged to be depressed (YES at step S126), the host VM 13 terminates execution of the move destination terminal selecting process. In the case that the cancel button has been judged not to be depressed (NO at step S126), the host VM 13 judges whether the move button has been depressed (step S127). In the case that the move button has been judged not to be depressed (NO at step S127), the host VM 13 returns the process to step S126 for judging whether the cancel button has been depressed. In the case that the move button has been judged to be depressed (YES a step S127), the host VM 13 transmits the move request to the host management OS 12 (step S128) and terminates execution of the move destination terminal selecting process.

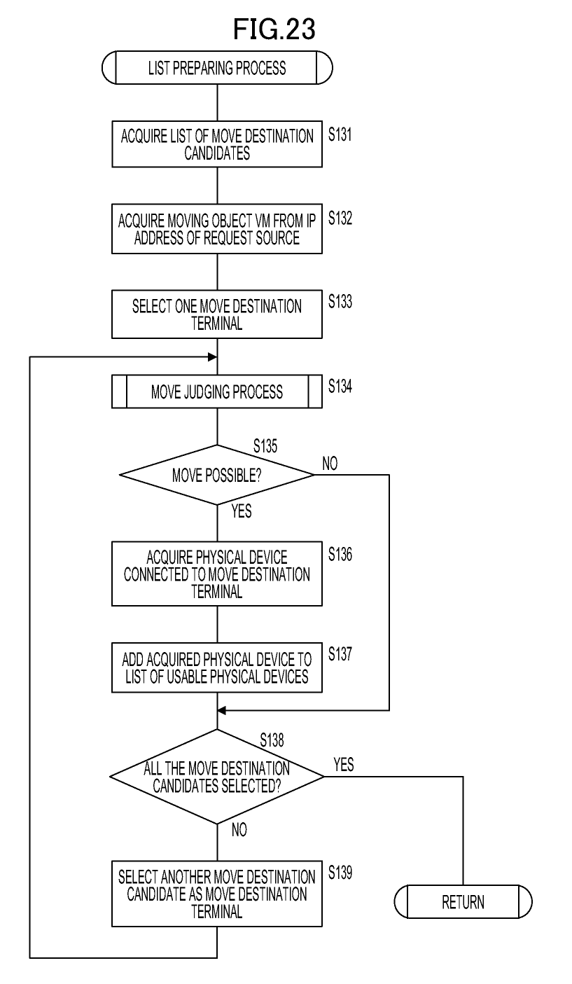

FIG. 23 illustrates processing of the list preparing process. The list preparing process is executed using the management server 2 at step S116 in FIG. 21. The management server 2 acquires the list of move destination candidates constituted by the client terminals 3 from the resource management unit 21 (step S131). The management server 2 acquires one host VM 13 as the moving object VM on the basis of the IP address of the source from which the list request has been given (step S132). The management server 2 selects one move destination terminal from the move destination candidates in the list (step S133). Then, the management server 2 executes a move judging process (step S134).

The management server 2 judges whether move is possible on the basis of a result of judgment obtained by executing the move judging process (step S135). In the case that the move has been judged to be possible (YES at step S135), the management server 2 acquires one physical device connected to the move destination terminal by referring to the resources information (step S136). The management server 2 adds the acquired physical devices to the list of usable physical devices (step S137). Then, the management server 2 judges whether all the move destination candidates included in the list of move destination candidates have already been selected (step S138).

In the case that it has been judged that all the move destination candidates have not yet been selected (NO at step S138), the management server 2 selects another candidate from the move destination candidates in the list as a move destination terminal (step S139). The management server 2 returns the process to step S134 for executing the move judging process. In the case that it has been judged that the move is not possible at step S135 for judging whether the move is possible (NO at step S135), the management server 2 shifts the process to step S138 for judging whether all the move destination candidates have been already selected. In the case that all the move destination candidates have been judged to be already selected (YES at step S138), the management server 2 terminates execution of the list preparing process.

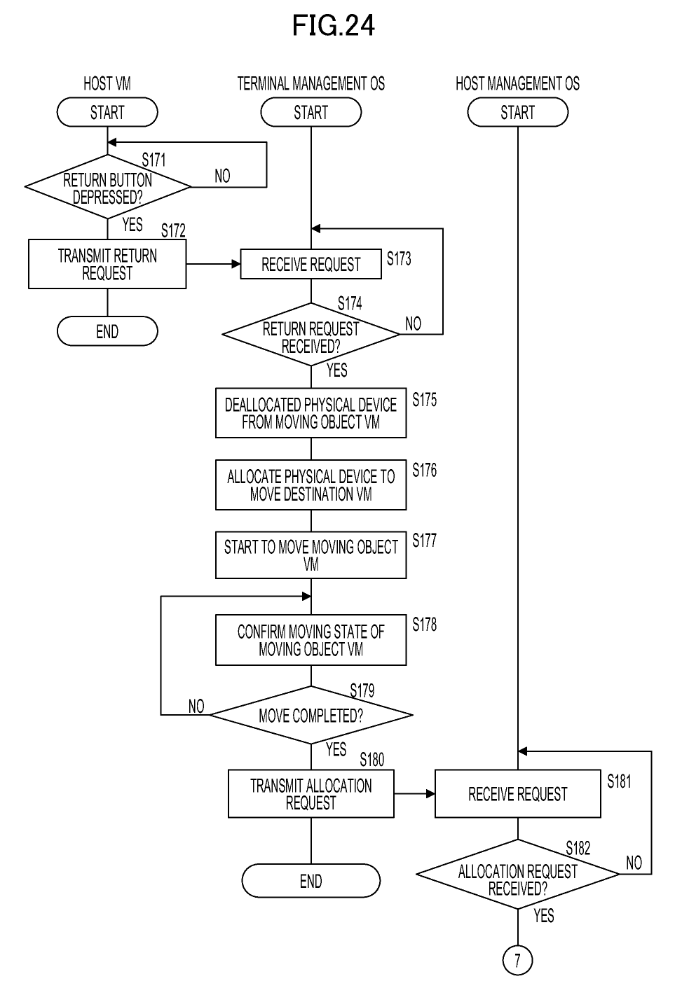

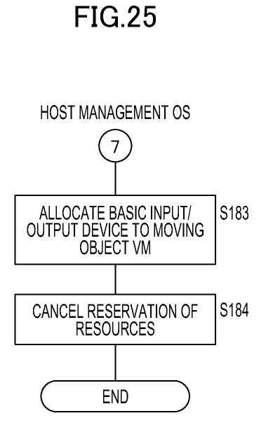

FIGS. 24 and 25 illustrate processing of a returning process. The returning process is executed in order that clicking of the return button displayed on the desktop screen is detected to return the moving object VM to the corresponding host server 1. The host VM 13 judges whether the return button has been depressed (step S171). In the case that the return button has been judged not to be depressed (NO at step S171), the host VM 13 waits until the return button is depressed. In the case that the return button has been judged to be depressed (YES at step S171), the host VM 13 transmits a return request to the terminal management OS 32 (step S172) and terminates execution of the returning process. The terminal management OS 32 receives a request (step S173) and judges whether the return request sent from the host VM 13 has been received (step S174). In the case that the return request has been judged not to be received (NO at step S174), the terminal management OS 32 returns the process to step S173 for receiving a request.

In the case that the return request has been judged to be received (YES at step S174), the terminal management OS 32 deallocates the physical device from the moving object VM (step S175). Then the terminal management OS 32 allocates the physical device to the move destination VM together with the basic input/output device (step S176). The terminal management OS 32 starts to move the host VM 13 as the moving object VM to the host server 1 (step S177). The terminal management OS 32 confirms the moving state of the moving object VM (step S178) and judges whether the moving operation has been completed (step S179). In the case that the moving operation has been judged not to be completed (NO at step S179), the terminal management OS 32 returns the process to step S178 for confirming the moving state of the moving object VM. In the case that the moving operation has been judged to be completed (YES at step S179), the terminal management OS 32 transmits a device allocation request to the host management OS 12 (step S180) and terminates execution of the returning process.

The host management OS 12 of the host server 1 receives a request (step S181) and judges whether the device allocation request sent from the terminal management OS 32 has been received (step S182). In the case that the device allocation request has been judged not to be received (NO at step S182), the host management OS 12 returns the process to step S181 for receiving a request. In the case that the device allocation request has been judged to be received (YES at step S182), the host management OS 12 allocates the basic input/output device to the host VM 13 as the moving object VM which has been moved to the host server 1 (step S183). The host management OS 12 cancels reservation of the resources of the moving object VM (step S184) and terminates execution of the returning process.

In the case that a usable physical device has been selected as a result of execution of the above mentioned process, it may become possible to gain access to the physical device concerned with no interposition of the network N by moving the host VM 13 to the client terminal 3. In the case that the operation of returning the host VM to the move source has been accepted, remote operation of the host VM 13 from the client terminal 3 may become possible by moving the host VM 13 back to the host server 1 which is the move source.

In this embodiment, although an example in which selection of the physical device connected to the client terminal 3 is accepted has been described, the embodiment is not limited to the above mentioned example and selection of a physical device which is expected to be connected to a client terminal 3 move of the host VM 13 to which is possible may be accepted. In the latter case, connection of the physical device may be waited after the host VM 13 has been moved from the host server 1 to the client terminal 3. In addition, although an example in which the physical device to which the client terminal 3 is connected is selected has been described, the embodiment is not limited to the above mentioned example. The embodiment may be configured to select a physical device which is connected to, for example, each of the plurality of host servers 1. In the latter case, one host VM 13 to which one client terminal 3 is remote-connected may be moved to another host server 1 to which the selected physical device is connected.

Although the computer system provided with the management server 2 has been described, the embodiment is not limited to the system of the above mentioned type. The resources management unit 21 is not included in the management server 2 and may be included in one host management OS 12 which is operated in any one of the plurality of host servers instead. This embodiment is not limited to a case using a hypervisor type VMM as in the case in the embodiment 1 and a VMM, for example, of a host OS type may be used instead.

The embodiment 2 is as described above and is the same as the embodiment 1 with respect to other points. Thus, the same numerals and process names as those in the embodiment 1 are assigned to the corresponding parts and detailed description thereof will be omitted.

### Embodiment 3

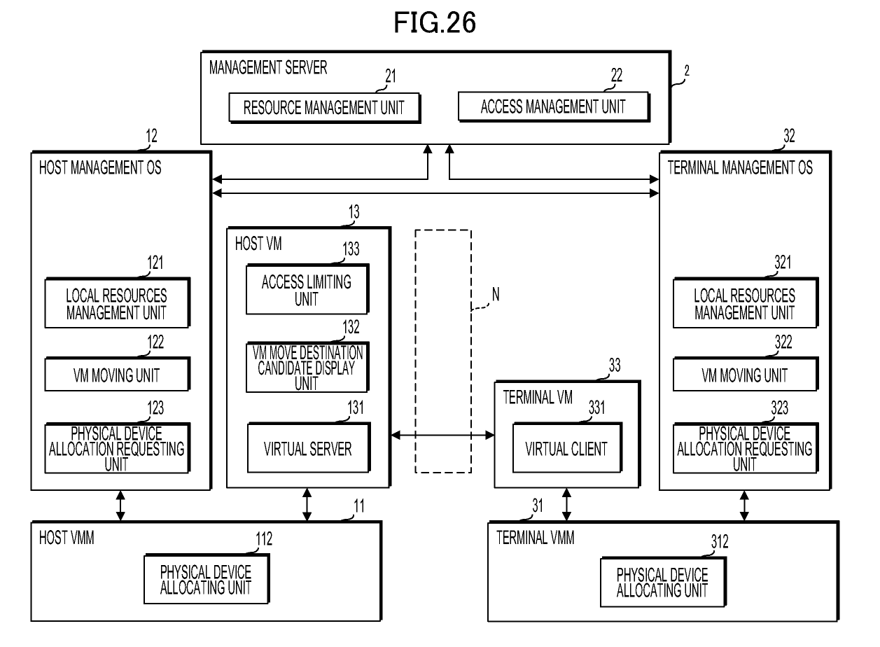

FIG. 26 illustrates an example of a functional configuration of each device. In this embodiment, access from the host VM 13 which has been moved to the client terminal 3 to the physical device is limited. The management server 2 includes an access management unit 22 for managing accessibility to each physical device connected to the client terminal 3 concerned. The host VM 13 includes an access limiting unit 133 for limiting access to the physical device on the basis of access limit information managed using the access managing unit 22 of the management server 2.

Next, summary of this embodiment will be described. The host VM 13 which has been moved to the client terminal 3 and to which the basic input/output device and the physical devices have been allocated turns accessible to each device. Incidentally, the operation of moving the host VM 13 and the operation of allocating each device to the host VM 13 are the same as those in the embodiments 1 and 2 and hence description thereof will be omitted. In the case that the host VM 13 gains access to each of the physical devices which have been allocated thereto, the access limiting unit 133 functions as a permitting unit by permitting the access to the device on the basis of access limit information which has been set in advance. Owing to the above mentioned operation, access to each physical device by the user who operates the client terminal 3 is limited, thereby preventing information from leaking to the outside of the computer system or preventing invalid data and programs from entering the computer system from the outside.

An access limit table includes data on accessibility according to each operation of each physical device. The operating state of each physical device may be periodically monitored using the access limiting unit 133 so as to limit the access in accordance with the operating state of each physical device. For example, in the case that a DVD-ROM for use in data reading alone has been inserted into a DVD multi-drive data writing into which is forbidden in accordance with the access limit information, the access may be permitted. In the above mentioned situation, in the case that the DVD-ROM inserted into the DVD drive has been replaced with a DVD-RAM data writing into which is possible, access to the DVD-ROM concerned is forbidden. Next, details of the above mentioned operations will be described.

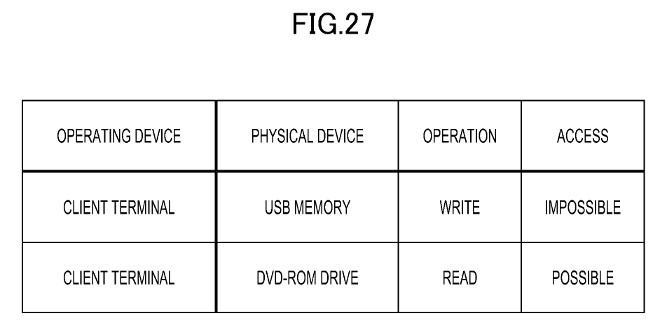

FIG. 27 illustrates an example of a record layout of the access limit table. The access management unit 22 is configured to store the access limit table in its storage unit so as to manage the access limit information. The access limit table includes access limit information of respective physical devices such as the USB memory 308a and the DVD-ROM drive 308b connected to the input/output unit 306 of each client terminal. The access limit information indicates the accessibility of each physical device corresponding to each operation and is determined and stored in advance by an administrator of a computer system. In the example illustrated in FIG. 27, as for the USB memory 308a connected to the client terminal 3, “Impossible” indicating that the access is not permitted with respect to its writing operation is stored. As for a DVD inserted into the DVD-ROM drive 308b, “Possible” indicating that the access is permitted with respect to its reading operation is stored.

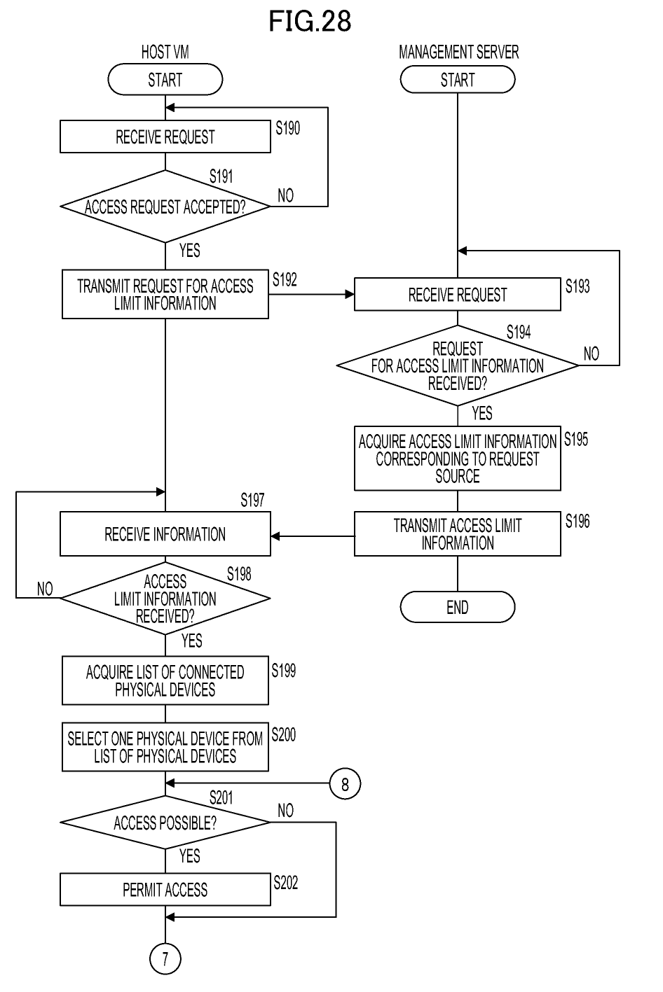

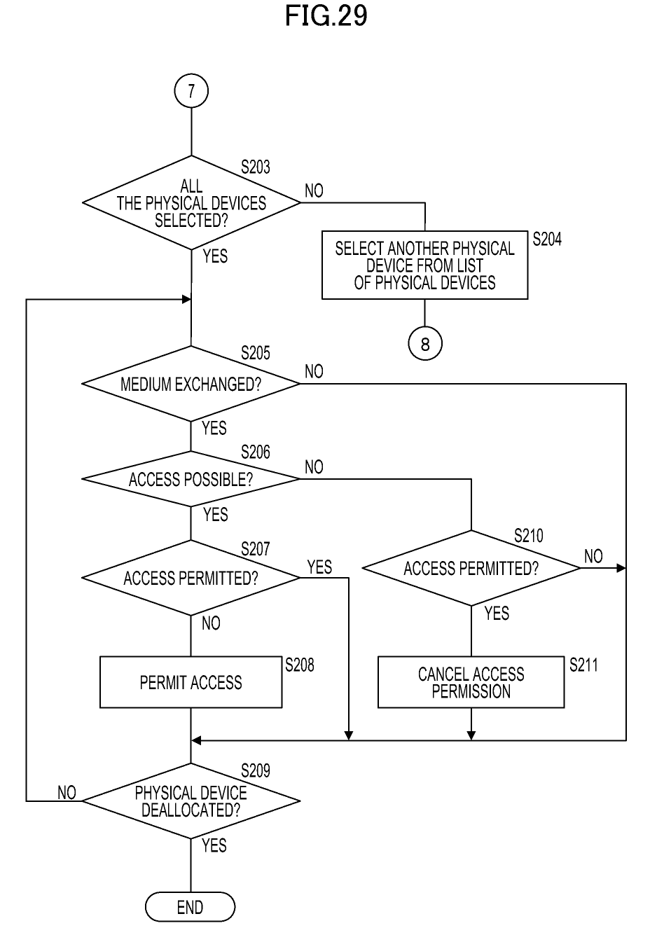

FIGS. 28 and 29 illustrate processing of an access limiting process. The access limiting process is executed in the case that physical devices have been allocated to the host VM 13 which has been moved to the client terminal 3. The host VM 13 receives a request (step S190) and judges whether an access request has been accepted (step S191). In the case that the access request has been judged not to be accepted (NO at step S191), the host VM 13 returns the process to step S190 for receiving a request. In the case that the access request has been judged to be accepted (YES at step S191), the host VM 13 transmits a request for access limit information corresponding to a physical device to be accessed to the management server 2. The management server 2 receives a request (step S193) and judges whether the request for access limit information sent from the host VM 13 has been received (step S194). In the case that the request for access limit information has been judged not to be received (NO at step S194), the management server 2 returns the process to step S193 for receiving a request.

In the case that the request for access limit information has been judged to be received (YES at step S194), the management server 2 acquires the access limit information corresponding to the client terminal 3 which is the request source using the access management unit 22 (step S195). The management server 2 transmits the acquired access limit information to the host VM 13 (step S196) and terminates execution of the access limiting process. The host VM 13 receives information (step S197) and judges whether the access limit information sent from the management server 2 has been received (step S198). In the case that the access limit information has been judged not to be received (NO at step S198), the host VM 13 returns the process to step S197 for receiving information. In the case that the access limit information has been judged to be received (YES at step S198), the host VM 13 acquires the list of connected physical devices (step S199).

The host VM 13 selects one physical device from the physical devices in the list (step S200). The host VM 13 judges whether access to the selected physical device is possible on the basis of the access limit information (step S 201). In the case that the access to the physical device has been judged to be possible (YES at step S201), the host VM 13 permits the access to the physical device (step S202). Then, the host VM 13 judges whether all the physical devices have already been selected (step S203). In the case that it has been judged that all the physical devices have not yet been selected (NO at step S203), the host VM 13 selects another physical device from the physical devices in the list (step S204) and returns the process to step S201 for judging whether access is possible. In the case that the access has been judged to be impossible at step S201 for judging whether the access is possible (NO at step S201), the host VM 13 shifts the process to step S203 for judging whether all the physical devices have already been selected.

In the case that it has been judged that all the physical devices have already been selected (YES at step S203), the host VM 13 judges whether a medium has been exchanged (step S205). In the case that the medium has been judged to be exchanged (YES at step S205), the host VM 13 judges whether access to the medium is possible (step S206). In the case that the access has been judged to be possible (YES at step S 206), the host VM 13 judges whether the access is permitted (step S207). In the case that the access has been judged not to be permitted (NO at step S207), the host VM 13 permits the access (step S208).

Then, the host VM 13 judges whether the physical device has been deallocated (step S209). In the case that the physical device has been judged not to be deallocated (NO at step S209), the host VM 13 returns the process to step S205 for judging whether a medium has been exchanged. In the case that the medium has been judged not to be exchanged at step S205 for judging whether the medium has been exchanged (NO at step S205), the host VM 13 shifts the process to step S209 for judging whether the physical device has been deallocated. In the case that the access has been judged not to be possible at step S206 for judging whether the access is possible (NO at step S206), the host VM 13 judges whether the access is permitted (step S210). In the case that the access has been judged not to be permitted (NO at step S210), the host VM 13 shifts the process to step S209 for judging whether the physical device has been deallocated.

In the case that the access has been judged to be permitted (YES at step S210), the host VM 13 cancels access permission (step S211) and shifts the process to step S209 for judging whether the physical device has been deallocated. In the case that the access has been judged to be permitted (YES at step S207) at step S207 for judging whether the access is permitted, the host VM 13 shifts the process to step S209 for judging whether the physical device has been deallocated. In the case that the physical device has been judged to be deallocated (YES at step S209), the host VM 13 terminates execution of the access limiting process. As a result of execution of the access limiting process, it may become possible to limit access from the host VM 13 to the physical device concerned on the basis of the access limit information which has been set in advance.

Although, in this embodiment, an example in which the basic input/output device and the physical device are allocated to the host VM 13 which has been moved to the client terminal 3 concerned and then the access to the physical device concerned is limited has been described, the embodiment is not limited to the above example. For example, only the basic input/output device may be allocated to the host VM 13 which has been moved to the client terminal 3 and then only the physical device access to which is permitted may be allocated to the host VM 13 on the basis of the access limit information. In the latter case, access from the host VM 13 to a physical device which is not allocated to the host VM 13 is impossible and hence the access to the physical device is forbidden.

Although in this embodiment, an example in which the management server 2 includes the access management unit 22 has been described, the embodiment is not limited to the above example. For example, the access management unit 22 is not included in the management server 2 and may be included in one host management OS 12 which is operated in any one of the plurality of host servers 1 instead.

The embodiment 3 is as described above and the embodiment 3 is the same as the embodiments 1 and 2 with respect to other respects. Accordingly, the same numerals and process names are assigned to the parts corresponding to those in the embodiments 1 and 2 and detailed description thereof has been omitted.

According to one viewpoint of the device concerned, access to a physical device may become possible with no interposition of a network by providing a moving unit for moving a virtual computer to a terminal device to which physical devices are connected.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.(Rewritable) An example of communication media includes a carrier-wave signal. The media described above are non-transitory media.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. A server device that operates a plurality of virtual computers so as to respectively correspond to a plurality of terminal devices to which physical devices are connected, the server device comprising:
a judging unit that judges whether a move of each of the plurality of virtual computers to each of the plurality of terminal devices is possible;
a moving unit configured to move a corresponding virtual computer to one of the plurality of terminal devices based on a judgment of the judging unit; and
an allocating unit that allocates a physical device connected to the terminal device to the virtual computer that has been moved to the terminal device by the moving unit.

2. The server device according to claim 1, further comprising:
a detecting unit that detects the physical devices connected to the plurality of terminal devices,
wherein the judging unit judges whether a move of the corresponding virtual computer to the terminal device to which the physical device that has been detected using the detecting unit is connected is possible.

3. The server device according to claims 1, further comprising:
a selecting unit that selects at least one of the physical devices connected to the plurality of terminal devices,
wherein the judging unit judges whether a move of the corresponding virtual computer to the terminal device to which the physical device that has been selected using the selecting unit is connected is possible.

4. The server device according to claim 3, further comprising:
a display unit that displays a list of physical devices connected to the terminal devices a move of the virtual computers to which has been judged to be possible using the judging unit; and
an operation accepting unit that accepts an operation of selecting at least one physical device from physical devices in the list displayed using the display unit,
wherein the selecting unit selects the physical device on the basis of the operation accepted using the operation accepting unit.

5. The server device according to claims 1, further comprising:
a storage unit that stores data on accessibility to each of the physical devices connected to the plurality of terminal devices; and
a permitting unit that permits access to the physical device that has been allocated using the allocating unit on the basis of the data on accessibility stored in the storage unit.

6. The server device according to claims 1, further comprising:
an allocating unit that allocates a physical device connected to the terminal device to the virtual computer that has been moved to the terminal device by the moving unit; and
a deallocating unit that deallocates the physical device that has been allocated using the allocating unit,
wherein the moving unit returns the virtual computer that has been moved to the terminal device to a move source when the physical device has been deallocated using the deallocating unit.

7. The server device according to claims 1,
wherein the judging unit judges whether a move of each of the plurality of virtual computers to each of the plurality of terminal devices is possible on the basis of computational resources that each of the plurality of terminal devices retains and computational resources that each of the plurality of virtual computers uses.

8. A computer system, comprising:
a plurality of terminal devices to which physical devices are connected; and
a server device which operates a plurality of virtual computers so as to respectively correspond to the plurality of terminal devices, wherein
the server device comprises:
a judging unit that judges whether a move of each of the plurality of virtual computers to each of the plurality of terminal devices is possible; and
a moving unit configured to move a corresponding virtual computer to one of the plurality of terminal devices based on a judgment of the judging unit, and
each of the terminal devices comprises:
an allocating unit that allocates one physical device to the virtual computer that has been moved using the moving unit.

9. The computer system according to claim 8, further comprising:
a management device that manages computational resources that each of the plurality of terminal devices retains and computational resources that each of the plurality of virtual computers uses,
wherein the judging unit judges whether a move of each of the plurality of virtual computers to each of the plurality of terminal devices is possible on the basis of the computational resources managed using the management device.

10. The computer system according to claims 8,
wherein the management device further comprises:
a storage unit that stores data on accessibility to each of the physical devices connected to the plurality of terminal devices, and
wherein the server device further comprises:
a permitting unit that permits access to the physical device that has been allocated using the allocating unit on the basis of the data on accessibility stored in the storage unit.

11. A computer-readable storage medium storing a program, the program causing a computer to perform a method that causes a server device that operates a plurality of virtual computers so as to respectively correspond to a plurality of terminal devices to which physical devices are connected to move the virtual computers respectively to the plurality of terminal devices. with the method comprising:
judging whether a move of each of the plurality of virtual devices to each of the plurality of terminal device is possible using the server device;
moving a corresponding virtual computer to one of the terminal devices based on the judging; and
allocating a physical device connected to the terminal device to the moved virtual computer using the moving.

12. A virtual computer moving method that moves a plurality of virtual computers provided so as to respectively correspond to a plurality of terminal devices to which physical devices are connected to the plurality of terminal devices, the virtual computer moving method comprising:
judging whether a move of each of the plurality of virtual computers to each of the plurality of terminal devices is possible;
moving a corresponding virtual computer to one of the terminal devices based on the judging; and
allocating a physical device connected to the terminal device concerned to the moved virtual computer.

13. A computer-readable storage medium storing a program for terminal devices, the program causing a computer to function with:
detecting physical devices connected to each of the terminal devices; and
notifying a detecting unit of the physical devices detected at the detecting.
